(19) United States
(12) Patent Application Publication
(10) Pub. No.: US 2010/0293290 A1
(43) Pub. Date: Nov. 18, 2010

(54) RELAY DEVICE, TERMINAL, PRIORITY COMMUNICATION CONTROL METHOD, PROGRAM, AND RECORDING MEDIUM

(76) Inventors: Nobuhiko Arashin, Osaka (JP); Osamu Tanaka, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/812,654

(22) PCT Filed: Jan. 23, 2009
(86) PCT No.: PCT/JP2009/000271

§ 371 Date: Jul. 13, 2010

(30) Foreign Application Priority Data
Jan. 25, 2008 (JP) 2008-015604

(51) Int. Cl. G06F 15/16; G06F 3/01

(52) U.S. Cl. 709/232; 715/736

(57) ABSTRACT

To smoothly deliver data while guaranteeing real-time properties on home network which takes into account data capturing from public network, a relay device connects one or plural delivery servers having content stored therein, one or plural video display terminals and one or plural other PCs, the video display terminal including a user IF which receives the content stored on the delivery server and acquires information for specifying content according to an input of a user, an acquiring unit which acquires specifying information for specifying the delivery server having stored therein the content specified by the information, and a transmitting unit which transmits the specifying information acquired by the acquiring unit, to the relay device, and the relay device performs data transfer between the delivery server and the video display terminal at a predetermined priority set on the basis of the specifying information received from the video display terminal.

### CROSS-REFERENCE TO RELATED APPLICATIONS

This application is a U.S. national phase application of PCT International Patent Application No. PCT/JP2009/000271 filed Jan. 23, 2009, claiming the benefit of priority of Japanese Patent Application No. 2008-015604 filed Jan. 25, 2008, all of which are incorporated by reference herein in their entirety.

### TECHNICAL FIELD

The present invention relates to a relay device, a terminal, a priority communication control method, a program, and a recording medium. For example, the present invention relates to a relay device, a terminal, a priority communication control method, a program, and a recording medium which realize, in a house, real-time processing of streaming data from a public network, under a configuration for performing data communication to which priority-based QoS (Quality of Service) is applied.

### BACKGROUND ART

According to the spread of the data communication via networks such as the Internet and a LAN, home network in which home appliances, computer, and other peripheral apparatuses are connected through networks to realize communication between the machinery, is often used in home. The home network enables, for example, content transmission and reception among the network-connected apparatuses and provides users with convenience and comfort. In future, further spread of the home networks is expected.

For example, in a home an apparatus having a receiving unit such as a tuner and a storing instrument such as a hard disk, is set as a server. Contents such as a movie stored in the server are transmitted to a client apparatus such as a PC of a user via a network and thereby such reproduction while executing data reception on a client side, that is so-called streaming data delivery and reproduction processing can be realized.

However in some case, plural communication data conflict with each other on the network. When such plural communication data conflict with each other, communication bands become insufficient, and a problem such as a delay in delivery of streaming data occurs.

For this problem, IEEE802.1D which is one of standards concerning a radio network, specifies a mechanism of so-called priority-based QoS which performs communication control according to the priority attached to packets in a wired LAN such as the Ethernet (registered trademark).

The WiFi forum specifies a priority-based WMM (WiFi-Multimedia) which is a sub-set of a QoS standard 802.11e for a wireless LAN.

These priority-based QoS techniques are easily implemented and have effectiveness compared with bandwidth-reservation-based QoS. Therefore, in a DLNA (Digital Living Network Alliance) guideline specified by a digital living network which is an industrial standard of a home network technique, both 802.1D and WMM are adopted.

On the other hand, there are provided a method and a system for performing QoS guarantee with high universality and economy, which enable system construction and bandwidth control even when a standard protocol is used for transmission and reception of signals between a terminal apparatus of a user and an IP communication network, the standard protocol is also applied to a content server, and the content server is not implemented with the standard protocol, in a CDN (Contents Delivery Network) used in a public network (see, for example, Japanese Patent Laid-Open No. 2005-12655).

A block diagram showing a configuration example of a QoS guarantee system in a CDN by a conventional SIP session control, is shown in FIG. 41.

A conventional priority communication control method shown in FIG. 41 is realized in a system including an IP communication network 111, a terminal apparatus 121 of a user 171, an SIP session control sub-system 131, a bandwidth control sub-system 141, a content delivery sub-system 151, and a content address management server sub-system 161.

The terminal apparatus 121 and the sub-systems 131, 141, 151, and 161 are connected to the IP communication network 111. The terminal apparatus 121 of a viewer of content acquires an address of the content from the content address management server sub-system 161 and requests, through the SIP session control sub-system 131, the content delivery sub-system 151 to establish a session prior to viewing of the content. The content delivery sub-system 151 notifies the SIP session control sub-system 131 of information concerning bandwidth necessary for the viewing of the content during the establishment of the session. The SIP session control sub-system 131 requests the bandwidth control sub-system 141 to perform bandwidth reservation according to the band information and notifies the terminal apparatus of a result of bandwidth securing. Consequently, QoS guarantee in the CDN is realized.

### DISCLOSURE OF THE INVENTION

### Problems to be Solved by the Invention

As described above, for the problem concerning the streaming data delivery of contents in the home network, measures are taken by the QoS specified by the DLNA. In the public network (CDN), the systems arranged on the IP communication network, cooperate with one another to thereby realize the QoS. Consequently, guarantee of streaming data is realized.

However, when it is attempted to capture the streaming data from the public network into the home network and receive the streaming data, deficiencies described below occur.

That is even if real-time properties of the streaming data is guaranteed on the public network by the conventional art shown in FIG. 41, it is likely that real-time properties of data delivery is not kept in the home network. This is because, since treatment of the streaming data from the public network is not specified in the DLNA, the streaming data is treated in the same manner as a packet not included in targets of the QoS of the DLNA and is not preferentially transmitted.

For this deficiency, it is conceivable to enable such treatment equivalent to the treatment of a streaming data packet specified in the DLNA, by also attaching priority to a streaming data packet from the public network. However, since a network policy of a communication carrier is different, it is unrealistic to attach the priority to a data packet in general which passes through the public network.

In some case, data which is not streaming data, i.e., data not requiring real-time properties from the public network, is also delivered to the home network. During reception of such data, it is also likely that the reception of the data affects delivery of stream data requiring real-time properties and not attached with priority, the delivery being executed between other apparatuses on the home network.

As described above, in the conventional QoS, there is a problem in that it is difficult to deliver data while guaranteeing real-time properties on the home network which takes into account data capturing from the public network.

The present invention has been devised in view of the problems in the conventional art and it is an object of the present invention to provide a relay device, a terminal, a priority communication control method, a program, and a recording medium, which can, in the conventional QoS, smoothly deliver data while guaranteeing real-time properties on the home network which takes into account data capturing from the public network.

### Means for Solving the Problems

To solve the above mentioned object, the 1^{st} aspect of the present invention is a relay device which controls data transfer between one or plural storage devices having content stored therein and one or plural terminals, the relay device comprising:

a transfer unit which performs, when apparatus information for specifying an apparatus concerning the data transfer of the content, is received from the terminal, the data transfer of the content at a predetermined priority set on the basis of the apparatus information.

The 2^{nd} aspect of the present invention is the relay device according to the 1^{st} aspect of the present invention, wherein

the apparatus information includes one or both of:

(1) information for specifying the storage device having the content stored therein; and

(2) information for specifying a terminal of a data transfer destination of the content.

The 3^{rd} aspect of the present invention is the relay device according to the 1^{st} aspect of the present invention, comprising:

a communication interface for transmitting and receiving data to and from the storage device and the terminal;

a transmission and reception processing unit which controls data received from the communication interface and data to be transmitted by the transmission and reception processing unit itself;

a relay control unit which applies relay control to the data from the communication interface; and

a protocol processing unit which processes a protocol from the terminal, wherein

the transfer unit includes

a priority control processing unit which processes a request for priority control and a request for release of the priority control from the terminal,

a priority control information managing unit which accumulates and manages information concerning the terminal and information necessary for the priority control, and

a priority control mechanism unit which performs priority control processing.

The 4^{th} aspect of the present invention is the relay device according to the 3^{rd} aspect of the present invention, wherein,

when a request for the priority control is received from the terminal,

the priority control processing unit adds said predetermined priority to determination indexes for the priority processing, which are used in communication among the terminals, for determining priority from a field of data in which priorities are described, and performs the priority processing.

The 5^{th} aspect of the present invention is the relay device according to the 3^{rd} aspect of the present invention, wherein,

when a release request for the priority control is received from the terminal,

the priority control processing unit deletes the predetermined priority from determination indexes for the priority processing, which are used in communication among the terminals, for determining priority from a field of data in which priorities are described.

The 6^{th} aspect of the present invention is the relay device according to the 1^{st} aspect of the present invention, wherein

a function of the transfer unit is defined right below a root device.

The 7^{th} aspect of the present invention is a terminal connected to, via a relay device, one or plural storage devices having content stored therein,

the terminal comprising:

a user interface which acquires information for specifying content according to an input of a user;

a transmitting unit which transmits apparatus information for specifying an apparatus concerning data transfer of the content, to the relay device; and

a communication unit which performs data transfer with the storage device at a predetermined priority set by the relay device on the basis of the apparatus information received from the terminal.

The 8^{th} aspect of the present invention is the terminal according to the 7^{th} aspect of the present invention, wherein

the apparatus information includes one or both of:

(1) information for specifying the storage device having the content stored therein; and

(2) information for specifying the terminal itself, and

the terminal includes an acquiring unit which acquires information for specifying the storage device storing the content specified by the information.

The 9^{th} aspect of the present invention is the terminal according to the 7^{th} aspect of the present invention, wherein

the terminal belongs to a local network together with the relay device,

the storage device belongs to a wide area network, and

the information for specifying the content includes information for distinguishing the local network and the wide area network.

The 10^{th} aspect of the present invention is the terminal according to the 8^{th} aspect of the present invention, wherein

the acquiring unit acquires the information for specifying the storage device, from a metafile server belonging to the wide area network and having recorded therein the information for specifying the storage device having stored therein the content specified by the information.

The 11^{th} aspect of the present invention is the terminal according to the 8^{th} aspect of the present invention, further comprising:

a communication interface including the communication unit and for transmitting and receiving data to and from the storage device;

a transmission and reception processing unit which controls data received from the communication interface or data to be transmitted by the transmission and reception processing unit itself;

a protocol processing unit which processes a protocol with the relay device;

a terminal data processing unit which processes data from the storage device; and

a video display unit which outputs processed video to a screen, wherein

the acquiring unit includes

a priority control processing unit which searches for the relay device according to at least an input to the user interface and processes a request for priority control and a request for release of the priority control to the relay device,

a priority control information managing unit which accumulates and manages information necessary for performing the request for the priority control and the request for release of the priority control to the replay device, and

a priority control mechanism unit which performs priority control processing.

The 12^{th} aspect of the present invention is the terminal according to the 11^{th} aspect of the present invention, wherein,

when stream reproduction which requires real-time properties, from the storage device is executed, the priority control processing unit requests the relay device to set priority equal to or higher than priorities of other data and relay the data.

The 13^{th} aspect of the present invention is the terminal according to the 11^{th} aspect of the present invention, wherein,

when stream reproduction which does not require real-time properties, from the storage device is executed, the priority control processing unit requests the relay device to set priority equal to or lower than priorities of other data and relay the data.

The 14^{th} aspect of the present invention is a priority communication control method for controlling data transfer between one or plural storage devices having content stored therein and one or plural terminals, the priority communication control method comprising:

performing, when apparatus information for specifying content and an apparatus concerning data transfer of the content is received from the terminal, the data transfer between the storage device and the terminal at a predetermined priority set on the basis of the apparatus information.

The 15^{th} aspect of the present invention is a priority communication control method for performing control for causing a terminal connected to one or plural storage devices having content stored therein to receive data from the storage device via a relay device, the priority communication control method comprising:

a step of acquiring information for specifying the content according to an input of a user;

a step of transmitting apparatus information for specifying an apparatus concerning data transfer of the content to the relay device; and

a step of performing data transfer with the storage device at a predetermined priority set by the relay device on the basis of the apparatus information for specifying an apparatus concerning data transfer of the content, received from the terminal.

The 16^{th} aspect of the present invention is a program, embodied on a non-transitory computer-readable medium, for causing a computer to execute a priority communication control method for controlling data transfer between one or plural storage devices having content stored therein and one or plural terminals, the priority communication control method comprising: performing, when apparatus information for specifying content and an apparatus concerning data transfer of the content is received from the terminal, the data transfer between the storage device and the terminal at a predetermined priority set on the basis of the apparatus information.

The 17^{th} aspect of the present invention is a program, embodied on a non-transitory computer-readable medium, for causing a computer to execute a priority communication control method for performing control for causing a terminal connected to one or plural storage devices having content stored therein to receive data from the storage device via a relay device, the priority communication control method comprising:

acquiring information for specifying the content according to an input of a user;

transmitting apparatus information for specifying an apparatus concerning data transfer of the content, to the relay device; and

performing data transfer with the storage device at a predetermined priority set by the relay device on the basis of the apparatus information for specifying an apparatus concerning data transfer of the content, received from the terminal.

### Advantages of the Invention

According to the present invention described above, there is an advantage that it is possible to smoothly deliver data while guaranteeing real-time properties on the home network which takes into account data capturing from the public network.

### BRIEF DESCRIPTION OF THE DRAWINGS

FIG. 1 is a system diagram of a terminal used in priority communication control methods according to first and third embodiments of the present invention;

FIG. 2 is a diagram of a video display terminal in an embodiment of the present invention;

FIG. 3 is a diagram of a relay device in the embodiment of the present invention;

FIG. 4 is a template of UPnP of the relay device in the embodiment of the present invention;

FIG. 5 is a priority control service template of the relay device in the embodiment of the present invention;

FIG. 6 is a sequence chart of the start of priority control according to the first embodiment of the present invention;

FIG. 7 is a diagram showing information stored in a priority information managing unit after a video display terminal searches for a priority control adaptable relay device, in the priority communication control method according to the first embodiment of the present invention;

FIG. 8 is a diagram showing a metafile acquired by the video display terminal from a metafile server, in the priority communication control method according to the first embodiment of the present invention;

FIG. 9 is a diagram showing information stored in the priority information managing unit so that the video display terminal requests the priority control adaptable relay device to perform priority processing, in the priority communication control method according to the first embodiment of the present invention;

FIG. 10 is a diagram showing a priority processing request service in the priority communication control method according to the first embodiment of the present invention;

FIG. 11 is a diagram showing information stored in a priority control information managing unit when a relay device receives a priority processing request from the video display terminal, in the priority communication control method according to the first embodiment of the present invention;

FIG. 12 is a diagram showing a priority control mechanism unit of the relay device according to the first embodiment of the present invention;

FIG. 13 is a diagram showing a state in which a packet from a delivery server is given with priority, in the priority communication control method according to the first embodiment of the present invention;

FIG. 14 is a diagram showing a state in which a packet from the delivery server and a packet from the video display terminal are given with priority, in the priority communication control method according to the first embodiment of the present invention;

FIG. 15 is a sequence chart of release of priority control according to the first embodiment of the present invention;

FIG. 16 is a diagram showing a priority processing release service in the priority communication control method according to the first embodiment of the present invention;

FIG. 17 is a system diagram of a terminal used in priority communication control methods according to second and fourth embodiment of the present invention;

FIG. 18 is a sequence chart of the start of priority control according to the second embodiment of the present invention;

FIG. 19 is a diagram showing information stored in a priority information managing unit after a video display terminal searches for a priority control adaptable relay device, in the priority communication control method according to the second embodiment of the present invention;

FIG. 20 is a diagram showing information stored in the priority information managing unit so that the video display terminal requests a priority control adaptable relay device to perform priority processing, in the priority communication control method according to the second embodiment of the present invention;

FIG. 21 is a diagram showing a priority processing request service in the priority communication control method according to the second embodiment of the present invention;

FIG. 22 is a diagram showing information stored in a priority control information managing unit when a relay device receives a priority processing request from the video display terminal, in the priority communication control method according to the second embodiment of the present invention;

FIG. 23 is a diagram showing a state in which a packet from a video accumulating device is given with priority, in the priority communication control method according to the second embodiment of the present invention;

FIG. 24 is a diagram showing a state in which a packet from the video accumulating device and a packet from the video display terminal are given with priority in the priority communication control method according to the second embodiment of the present invention;

FIG. 25 is a sequence chart of the start of priority control according to the third embodiment of the present invention;

FIG. 26 is a diagram showing a metafile acquired by a video display terminal from a metafile server, in the priority communication control method according to the third embodiment of the present invention;

FIG. 27 is a diagram showing information stored in a priority information managing unit so that the video display terminal requests a priority control adaptable relay device to perform priority processing, in the priority communication control method according to the third embodiment of the present invention;

FIG. 28 is a diagram showing a priority processing request service in the priority communication control method according to the third embodiment of the present invention;

FIG. 29 is a diagram showing information stored in a priority control information managing unit managing unit when a relay device receives a priority processing request from the video display terminal in the priority communication control method according to the third embodiment of the present invention;

FIG. 30 is a diagram showing a state in which a packet from a delivery server is given with priority in the priority communication control method according to the third embodiment of the present invention;

FIG. 31 is a diagram showing a state in which a packet from the delivery server and a packet from the video display terminal are given with priority, in the priority communication control method according to the third embodiment of the present invention;

FIG. 32 is a sequence chart of the release of priority control according to the third embodiment of the present invention;

FIG. 33 is a diagram showing a priority processing release service in the priority communication method according to the third embodiment of the present invention;

FIG. 34 is a sequence chart of the start of priority control according to a fourth embodiment of the present invention;

FIG. 35 is a diagram showing information stored in a priority information managing unit after a video display terminal searches for a priority control adaptable relay device, in the priority communication control method according to the fourth embodiment of the present invention;

FIG. 36 is a diagram showing information stored in the priority information managing unit son that the video display terminal requests a priority control adaptable relay device to perform priority processing, in the priority communication control method according to the fourth embodiment of the present invention;

FIG. 37 is a diagram showing a priority processing request service in the priority communication control method according to the fourth embodiment of the present invention;

FIG. 38 is a diagram showing information stored in a priority control information managing unit managing unit when a relay device receives a priority processing request from the video display terminal in the priority communication control method according to the fourth embodiment of the present invention;

FIG. 39 is a diagram showing a state in which a packet from a video accumulating device is not given with priority in the priority communication control method according to the fourth embodiment of the present invention;

FIG. 40 is a diagram showing a state in which a packet from the video accumulating device and a packet from the video display terminal are not given with priority, in the priority communication control method according to the fourth embodiment of the present invention; and

FIG. 41 is a diagram showing a configuration example of a QoS guarantee system in a CDN in the conventional art.

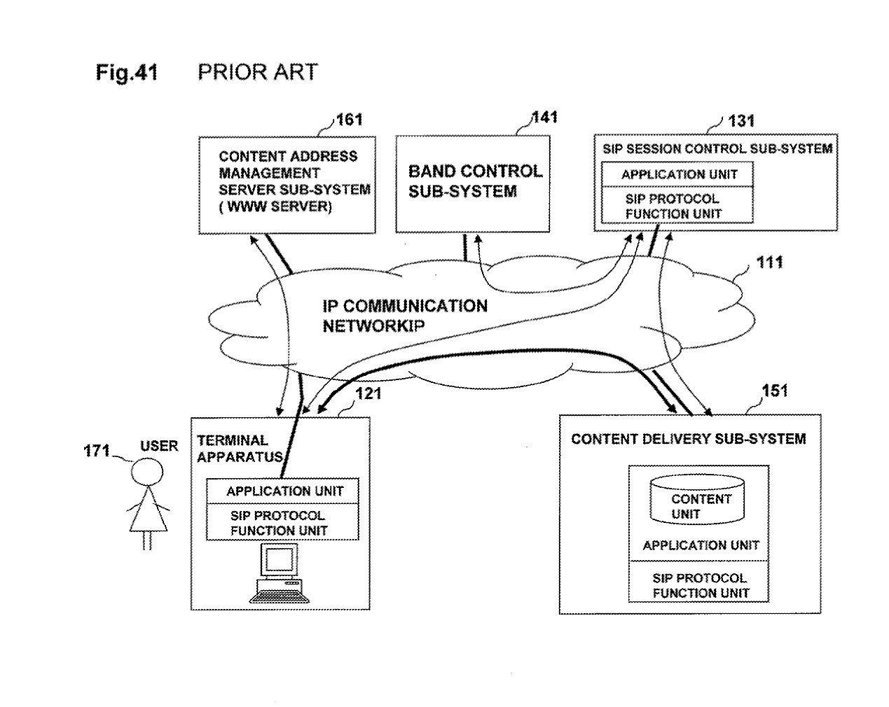

### DESCRIPTION OF SYMBOLS

1 delivery server
2 metafile server
3 Internet
4 IP public network
5 home network
6 relay device
7 video display terminal
8 PC
9 video display unit
10 priority control information managing unit of a video display terminal 7
11 priority control processing unit of the video display terminal 7
11a user IF
12 priority control mechanism unit of the video display terminal 7
13 wireless IF of the video display terminal 7
14 terminal video processing unit of the video display terminal 7
15 video display terminal transmission and reception processing unit of the video display terminal 7
16 UPnP processing unit of the video display terminal 7
17 wired IF
18 wired transmission and reception processing unit
19 a relay control unit 6
20 UPnP processing unit of a relay device 6
21 priority control mechanism unit of the relay device 6
22 priority control information managing unit of the relay device 6
23 priority control processing unit of the relay device 6
24 radio transmission and reception processing unit
25 wireless IF
26 to 37 UPnP devices, services, and actions held by the relay device
38 metafile for stream delivery
39 to 42 priority processing request UPnP action transmitted to the relay device by the video display terminal
43 classifier
44 queue
45 scheduler
46 to 47 priority release UPnP action transmitted to the relay device by the video display terminal
48 video accumulating device
49 to 52 priority processing request UPnP action transmitted to the relay device by the video display terminal
53 metafile for DL
54 to 57 priority release UPnP action transmitted to the relay device by the video display terminal
58 to 59 priority processing request UPnP action transmitted to the priority device by the video display terminal
60 to 63 priority processing request UPnP action transmitted to the relay device by the video display terminal

### BEST MODE OF EMBODIMENT OF THE INVENTION

Best modes for carrying out the present invention are described below with reference to the drawings.

### First Embodiment

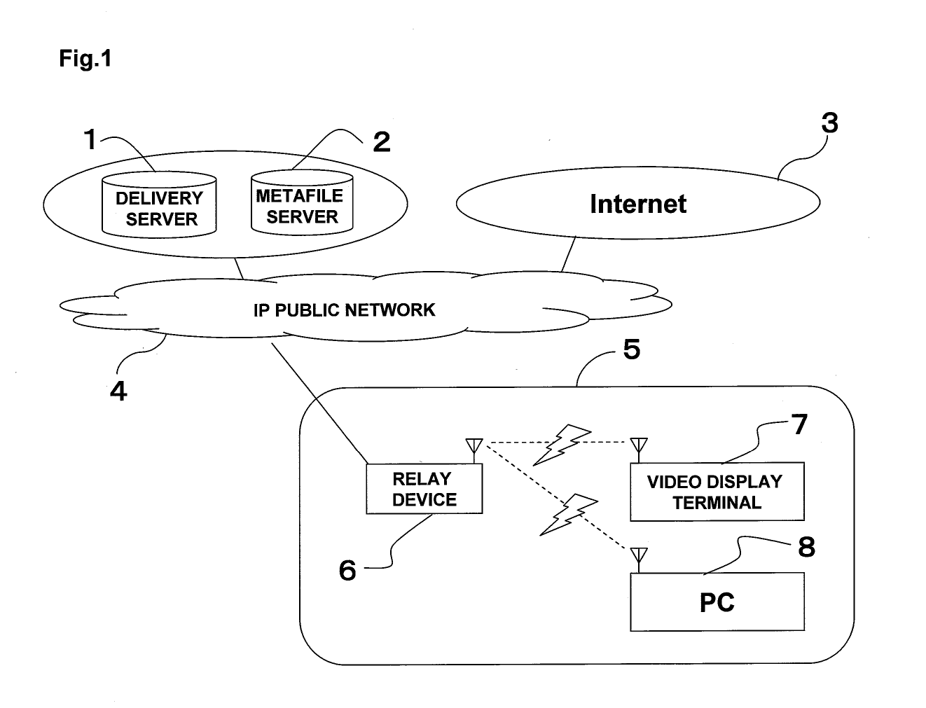

A diagram of a network system according to a first embodiment of the present invention, is shown in FIG. 1. A delivery server 1 for streaming content, a metafile server 2 which performs control of a metafile in which content information is described, and the Internet 3 on which other internet servers and the like are present, are connected to an IP public network 4.

A home network 5 is connected to the IP public network 4. A relay device 6 such as a router is set in this home network 5. Further, a video display terminal 7 and a PC 8 are connected to the relay device 6 through a wireless network.

An application assumed in the configuration of the network system shown in FIG. 1 is an application in which the PC 8 accesses the outside of a house via the relay device 6 present in the home network 5 by using the wireless network, so that a user enjoys the Internet 3 such as WEB browsing via the IP public network 4. Further the video display terminal 7 accesses the outside of the house via the relay device 6 present in the home network 5 by using the wireless network in the same manner as the PC 8, so that a user views streaming contents via the IP public network 4.

Concerning the system configuration, plural relay devices, plural video display devices, plural PCs, and the like can be present.

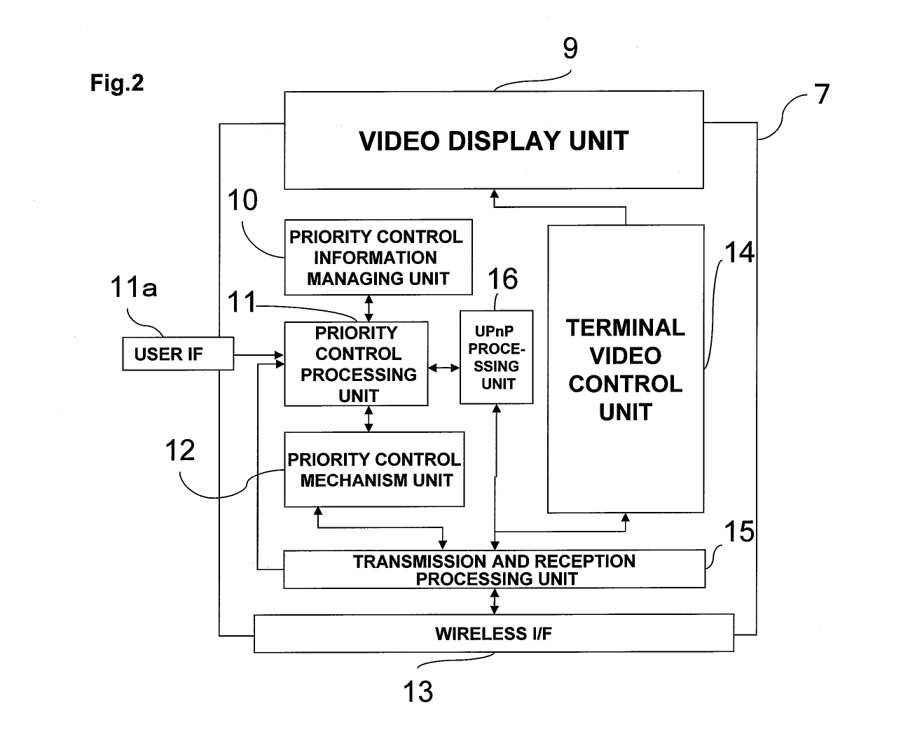

FIG. 2 is a diagram of the video display terminal 7 present in the home network 5 and used for viewing streaming contents from the IP public network 4.

The video display terminal 7 has a wireless interface (hereinafter referred to as IF) 13 and includes a transmission and reception processing unit 15 which processes data received from the wireless IF 13 or transmits data to the wireless IF 13, a priority control mechanism unit 12 which performs priority processing for data transmitted to the outside by the video display terminal 7 itself, a user IF 11a which receives an input from the user, a priority control processing unit 11 which processes a priority control message according to, for example, an input from the user IF 11a or automatically, a priority control information managing unit 10 which manages priority control information necessary for transmitting a priority processing request, a UPnP processing unit 16 which processes UPnP (Universal Plug and Play), a terminal video control unit 14 which processes received video data, and a video display unit 9 which displays the processed video data.

The video display terminal 7 is described as having the wireless IF 13. However, it goes without saying that the video display terminal 7 can have wired IF or other IFs.

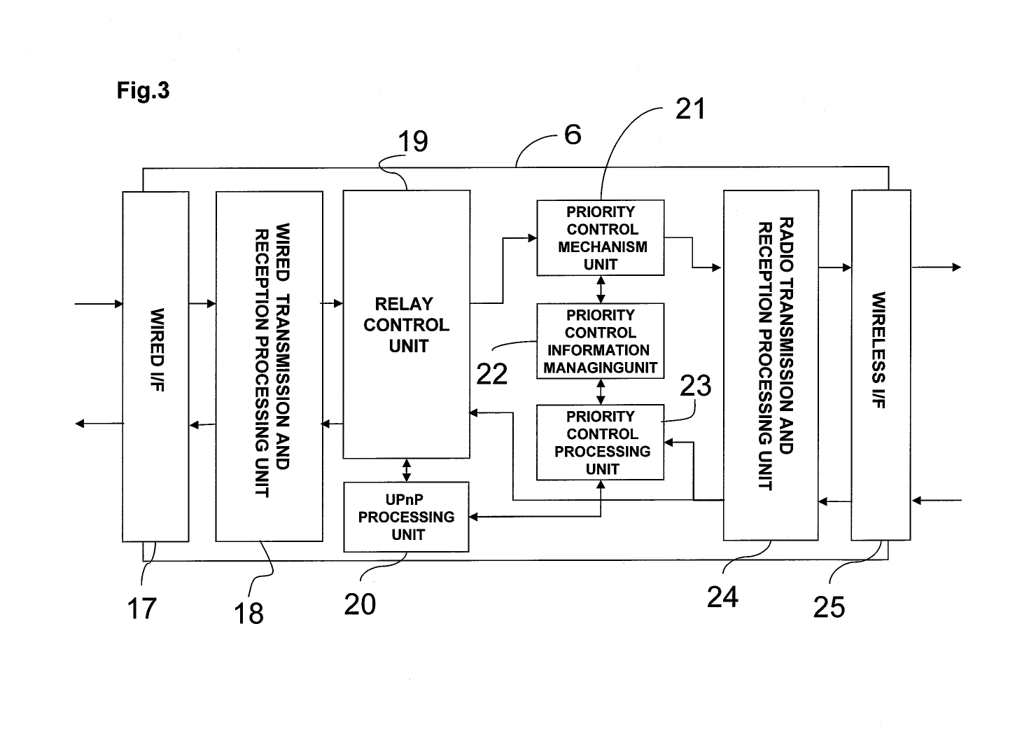

FIG. 3 is a block diagram of the relay device 6 which is present in the home network 5 and relays data of terminals included in the home network 5. The relay device 6 is a relay device having a wired IF 17 and a wireless IF 25. The relay device 6 includes a wired transmission and reception processing unit 18 which processes data received from the wired IF 17 or transmits data to the wired IF 17, a UPnP processing unit 20 which processes UPnP, a relay control unit 19 which applies relay processing to data received from the respective IFs, a priority control mechanism unit 21 which applies priority processing to data received from the wired IF 17, a priority control information managing unit 22 which manages priority control information necessary for transmitting a priority processing request, a priority control processing unit 23 which processes a priority control message, and a radio transmission and reception processing unit 24 which processes data received from the wireless IF 25 or transmits data to the wireless IF 25. The relay device 6 is described as having the wired IF 17 and the wireless IF 25. However, it goes without saying that the relay device 6 can have other IFs.

In the configuration described above, the network system shown in FIG. 1 is corresponding to a network system of the present invention, the IP public network 4 is corresponding to a wide area network of the present invention, and the home network 5 is corresponding to a local network of the present invention.

The delivery server 1 is corresponding to a storage device of the present invention, the metafile server 2 is corresponding to a metafile server of the present invention, the relay device 6 is corresponding to a relay device of the present invention, and the video display terminal 7 and the PC 8 are corresponding to a terminal of the present invention.

In the video display terminal 7, the wireless IF 13 is corresponding to a communication interface of the present invention, which configures a transmission unit and a communication unit of the present invention. The transmission and reception processing unit 15 is corresponding to a transmission and reception processing unit of the present invention and the UPnP processing unit 16 is corresponding to a protocol processing unit of the present invention. The priority control information managing unit 10, the priority control processing unit 11, and the priority control mechanism unit 12 are respectively corresponding to a priority control information managing unit, a priority control processing unit, and a priority control mechanism unit of the present invention, which configure an acquiring unit of the present invention. The user IF 11a is corresponding to a user interface of the present invention. The terminal video control unit 14 is corresponding to a terminal data processing unit of the present invention and the video display unit 9 is corresponding to a video display unit of the present invention.

In the relay device 6, the wired IF 17 and the wireless IF 25 are corresponding to a communication interface of the present invention, the wired transmission and reception processing unit 18 and the radio transmission and reception processing unit 24 are corresponding to a transmission and reception processing unit of the present invention, the relay control unit 19 is corresponding to a relay control unit of the present invention, and the UPnP processing unit 20 is corresponding to a protocol processing unit of the present invention. The priority control mechanism unit 21, the priority control information managing unit 22, and the priority control processing unit 23 respectively corresponding to a priority control mechanism unit, a priority control information managing unit, and a priority control processing unit of the present invention, which configure a transmitting unit of the present invention.

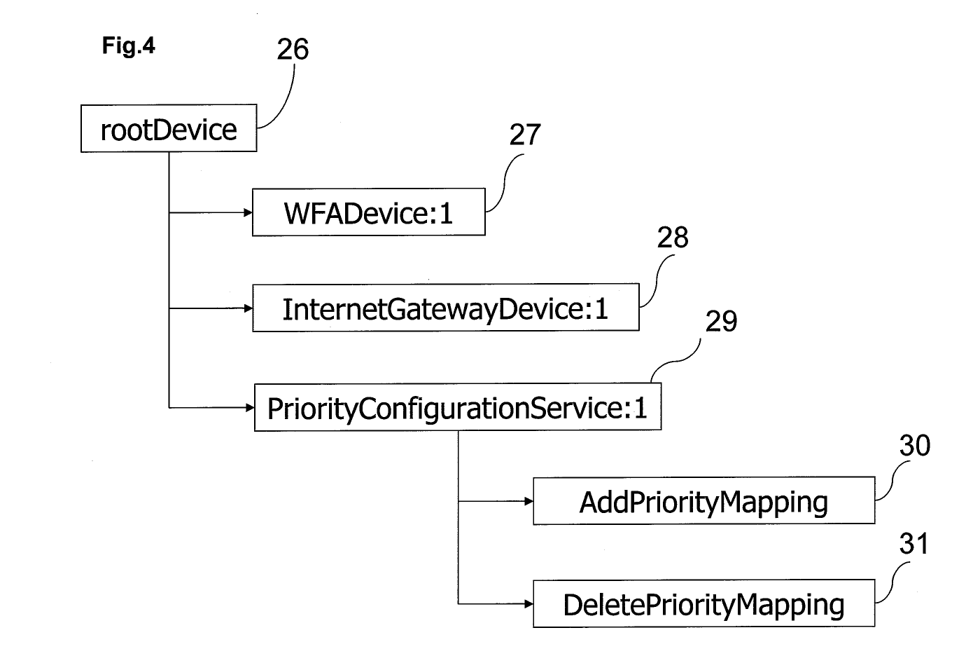

The video display terminal 7 operates as a control point in a UPnP-DA (Device Architecture). The relay device 6 operates as a device in the UPnP-DA and keeps a device template and a service template shown in FIG. 4.

The relay device 6 keeps, right below a root Device 26, a WFA Device 27 which means a radio device and an Internet Gateway Device 28 which means a relay device. Description is omitted concerning services, actions, and the like of these two devices.

Further, the relay device 6 keeps, right below the root Device 26, a Priority Configuration Service 29 which means that a function for priority control of the present invention is kept.

The Priority Configuration Service 29 is placed right below the root Device 26. Consequently, even if the Internet Gateway Device 28 is not present when the relay device 6 operates as a bridge device, it is possible to execute priority control as a service and to apply the priority control without depending on an IF. In an example shown in FIG. 4, the Priority Configuration Service 29 is kept as a service template. However, the Priority Configuration service 29 can be kept as a device template. In this case, since the Priority Configuration Service 29 is arranged right below the root Device 26, it is possible to execute the priority control as a device.

In the Priority Configuration Service 29, action Add Priority Mapping 30 which means addition of priority processing and action Delete Priority Mapping 31 which means release of priority processing, are defined. Concerning the action concerning the priority control, other actions can be kept.

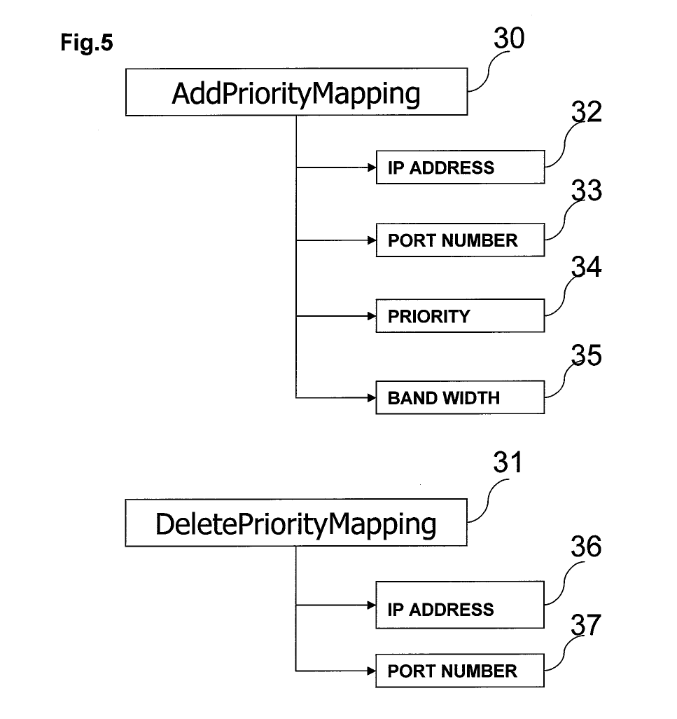

The Add Priority Mapping 30 keeps four arguments shown in FIG. 5, necessary for the relay device 6 to perform priority control. The respective arguments are an IP address 32 of the content delivery server 1, a delivery server port number 33 for content viewed by the video display terminal 7, priority 34, and a content use band 35. Concerning the arguments, other arguments can be kept.

The Delete Priority Mapping 31 keeps two arguments shown in FIG. 5, necessary for the relay device 6 to release the priority control. The respective arguments are an IP address 36 of the content delivery server 1 and a delivery server port number 37 for content viewed by the video display terminal 7. Concerning the arguments, other arguments can be kept. The IP address 32 and the IP address 36 of the content delivery server 1 in FIG. 5 are corresponding to information for specifying a storage device having stored therein content and is corresponding to apparatus information for specifying an apparatus concerning data transfer for content, of the present invention. The information for specifying a storage device can be information other than an IP address and a port number as long as a storage device and a terminal can be uniquely specified from the information. The apparatus information can be information for specifying a terminal which requests data transfer of content. As the information for specifying a terminal such information can be possible as long as it can uniquely specify the terminal, such as an IP address of the terminal.

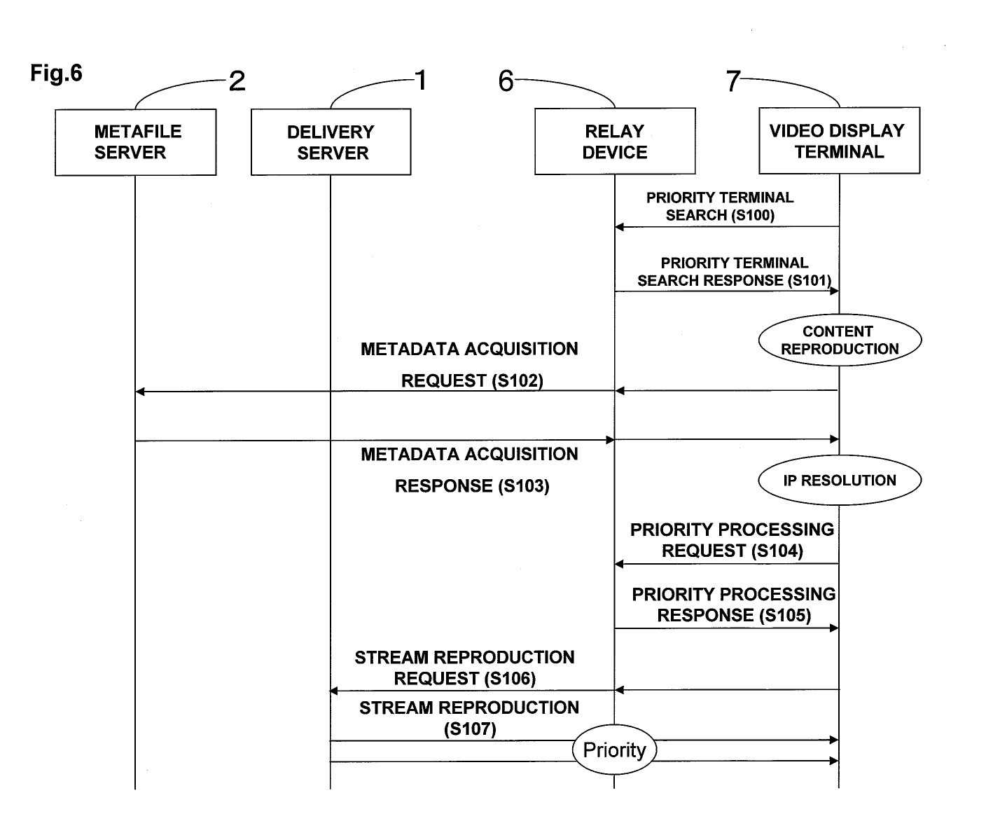

The operation of the network system according to the first embodiment of the present invention, having the configuration described above is described. According to the description the operation of a relay device according to the first embodiment of the present invention, the operation of a terminal, and a sequence as an embodiment of a priority communication control method of the present invention, are described with reference to a timing chart of FIG. 6.

First, the video display terminal 7 transmits, using UPnP, priority terminal search for searching for a relay device 6 which can apply priority processing to streaming data to be reproduced (S100). The relay device 6 which can apply the priority processing is synonymous with a device which keeps the Priority Configuration Service 29. That is, the video display terminal 7 searches for the Priority Configuration Service 29 with M-SEARCH.

The relay device 6 which keeps the Priority Configuration Service 29 responds to the video display terminal 7 (priority terminal search response) (S101).

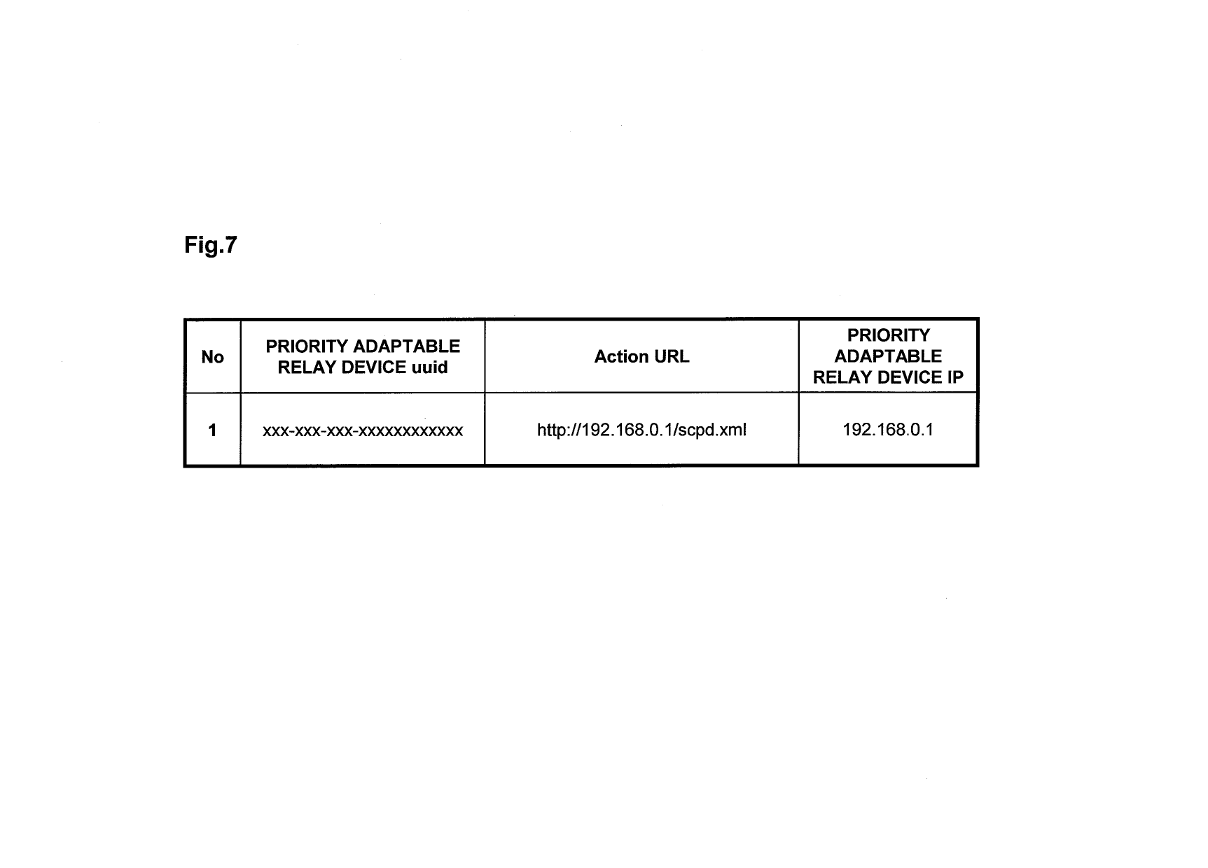

The video display terminal 7 which has received the response from the relay device 6 stores information shown in FIG. 7 in the priority control information managing unit 10 as priority control information. The information is, for example, uuid of the relay device 6, a URL for executing the Priority Configuration Service 29, and an IP address of the relay device 6. Concerning the priority control information, other priority control information can be stored.

When the video display terminal 7 is instructed to reproduce content requiring real-time properties from the IP public network 4 by the user, the video display terminal 7 requests acquisition of a metafile 38 necessary for reproducing the content from the metafile server 2 (S102).

At this point, priori to the reproduction instruction for the content requiring real-time properties, the user needs to specify, with the user IF 11a, content desired to be reproduced. However, it is assumed that a location of information for specifying the content is also the metafile server 2. Therefore, in the operation in S102, the specifying of the content as a reproduction target is also applied to the metafile server 2.

However, the location of the information for specifying the content is not limited to the metafile server 2. The location can be a not-shown storing unit in the video display terminal 7, not-shown another server on the Internet 3, or not-shown another terminal on the home network 5. In this case, the video display terminal 7 acquires the information for specifying the content from the storing unit, the server, or the like, learns the location of the metafile server 2 according to a response from the storing unit or the server, and, then, sends an acquisition request for the metafile 38 to the metafile server 2.

The metafile server 2 responds to a metafile acquisition request from the video display terminal 7 and supplies the metafile 38 requested by the video display terminal 7 (S103).

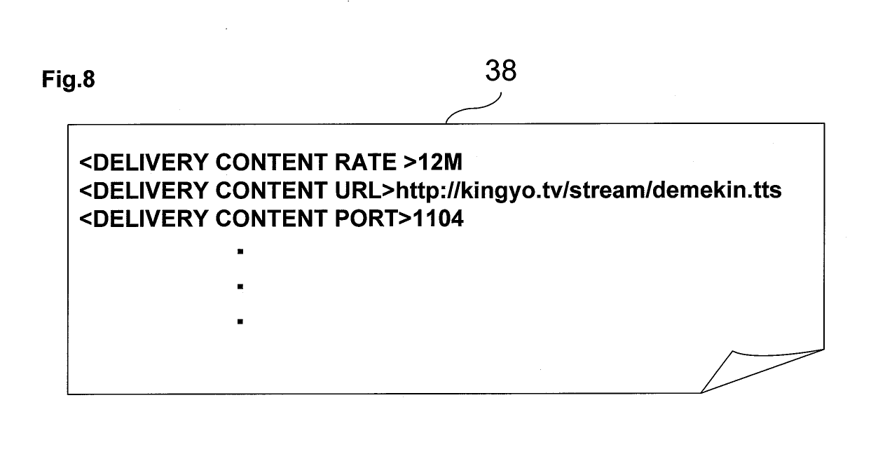

Information shown in FIG. 8 is described in this metafile 38. The information is a delivery content rate, a URL of delivered content, a port number of the delivered content, and the like. A form of this metafile 38 is not specifically limited. It is enough that information necessary for the video display terminal 7 to reproduce content is described.

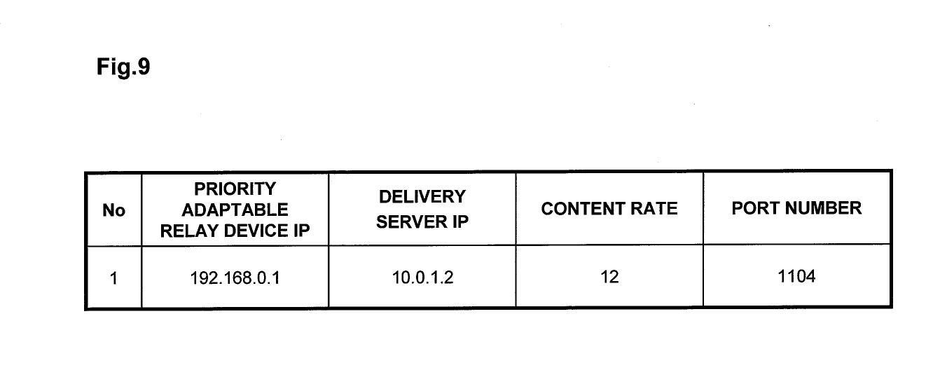

When the URL of the delivered content is described in the metafile 38, the video display terminal 7 attempts to resolve an address using a DNS in order to acquire the content. When the resolution of the address ends and an IP address of the delivery server 1 is found (IP of the delivery server 1=10.0.1.2), the video display terminal 7 stores information shown in FIG. 9 necessary for transmitting a priority processing request to the relay device 6, in the priority control information managing unit 10 as priority control information. The priority control information is the IP address of the relay device 6, the IP address of the delivery server 1, a content rate, and a port number of the content. The IP address of the delivery server 1 is corresponding to information for specifying a storage device of the present invention. The information for specifying a storage device can be information other than an IP address as long as the storage device can be uniquely specified from the information.

However, this is only an example and other kinds of information can be stored. For example, the priority control information can be information other than the information for specifying a storage device and can be an own IP address. The own IP address is corresponding to information for specifying a terminal itself of the present invention. The information for specifying a terminal can be information other than an IP address as long as the terminal itself can be specified from the information. The port number of the content can be a port number used by itself during reception of the content.

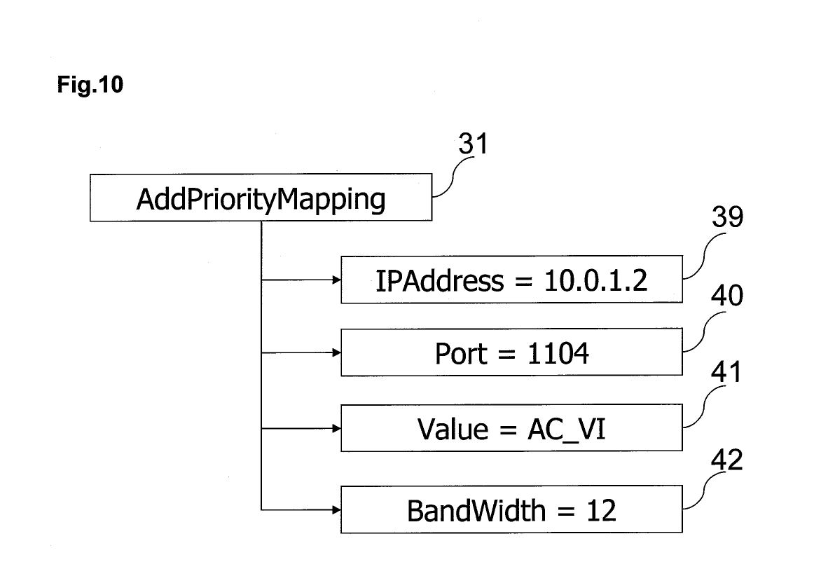

The video display terminal 7 transmits a priority processing request using the information stored in the priority control information managing unit 10 (S104). The video display terminal 7 performs this request using an action of UPnP. That is, the video display terminal 7 transmits an action shown in a service template of FIG. 10 to the Add Priority Mapping 30 of an action of the Priority Configuration Service 29 which is a service of priority control kept by the relay device 6. The video display terminal 7 stores (10.0.1.2) as an IP address 39 of the delivery server 1 in IPAddress, stores 1104 as a port number 40 of the content in Port, determines, with the priority control processing unit 11, that the started application requires real-time properties, stores AC_V141 representing priority specified by the DLNA in Value, stores 12 as a content rate in BandWidth 42, and transmits the action.

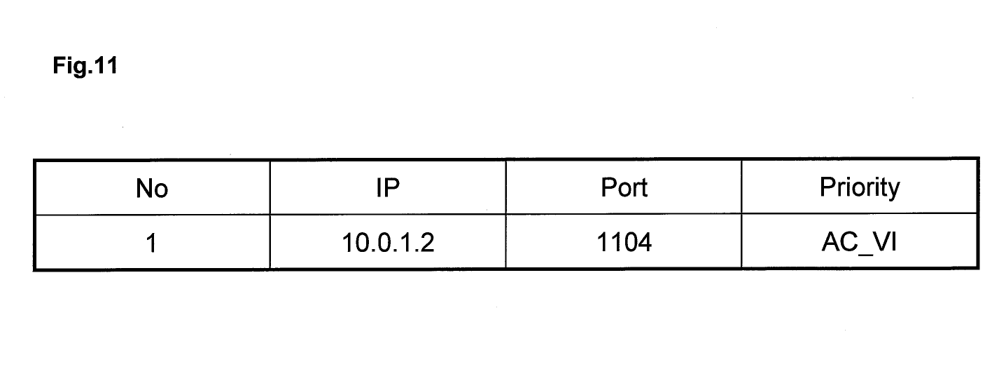

The relay device 6 which has received the priority processing request transmits a priority processing response (S105). The relay device 6 stores, in the priority control information managing unit 22, priority control information shown in FIG. 11 necessary for applying priority processing to data to be received by the video display terminal 7. The stored priority control information is the IP address of the delivery server 1, the port number of the content, and the priority specified by the DLNA.

The video display terminal 7 sends a request for acquisition of content to the delivery server 1 (S106), receives delivery of stream data from the delivery server 1, and starts stream reproduction (S107).

During the stream reproduction, the relay device 6 applies priority processing to a packet which coincides with the information indicated by the video display terminal 7.

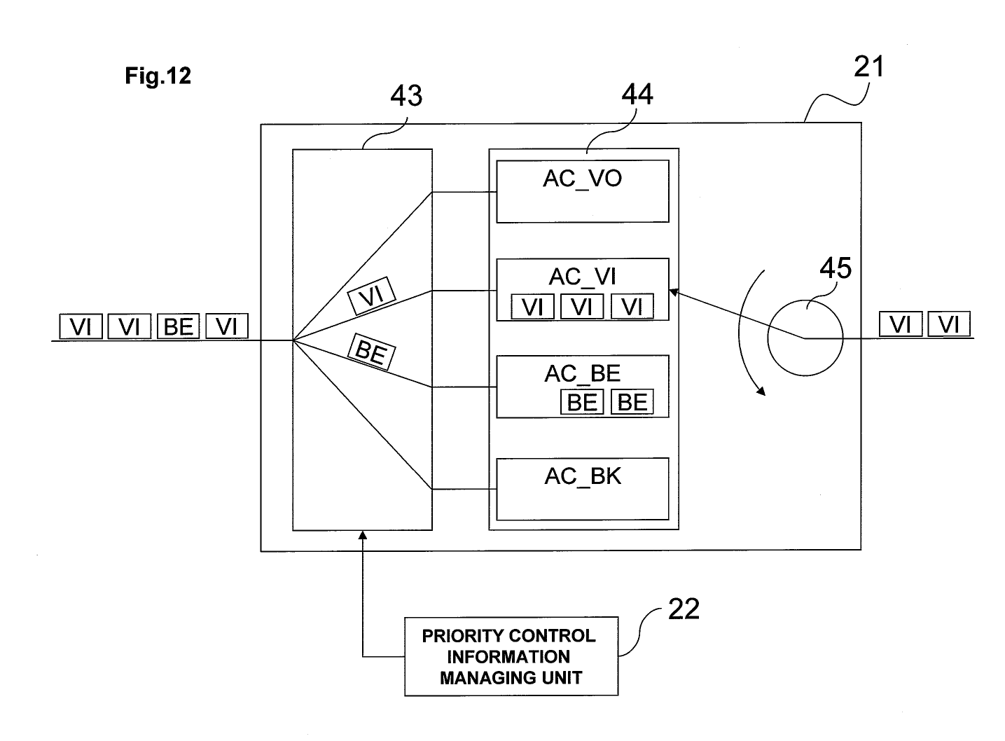

That is, the relay device 6 realizes, according to processing of the units shown in FIG. 12, priority processing of the present invention in addition to the priority processing specified by the conventional DLNA. FIG. 12 is a diagram schematically showing the configuration near the priority control mechanism unit 21.

In general, in the DLNA, priorities in four stages are specified. The priorities are AC_VO with highest priority used for data having small tolerance to a delay or jitter like VoIP etc., AC_VI used for video data requiring real-time properties, AC_BE used for normal data, and AC_BK used for background data.

When a data packet to be transmitted and received in the home network 5, enters the relay device 6, first, a classifier 43 performs classification of the packet. As a criterion for the classification, ToS or DSCP representing the priority of an IP packet or a priority field in a VLAN tag is used. After classifying the packet, the classifier 43 queues the packet in appropriate queues 44. The queued data packet is scheduled by a scheduler 45. Data in a queue having high priority is preferentially transmitted.

On the other hand, priority control of the present invention is performed as described below. The relay device 6 which has received a priority processing request from the video display terminal 7 adds priority control information based on the information stored in the priority control information managing unit 22 from the video display terminal 7, to the classification criterion of the classifier 43 in the priority control mechanism unit 21 and preferentially transmits content data to be received by the video display terminal 7 under such manner that the content data has the priority AC_VI corresponding to video data transfer which has the second highest priority in the priorities specified by the DLNA.

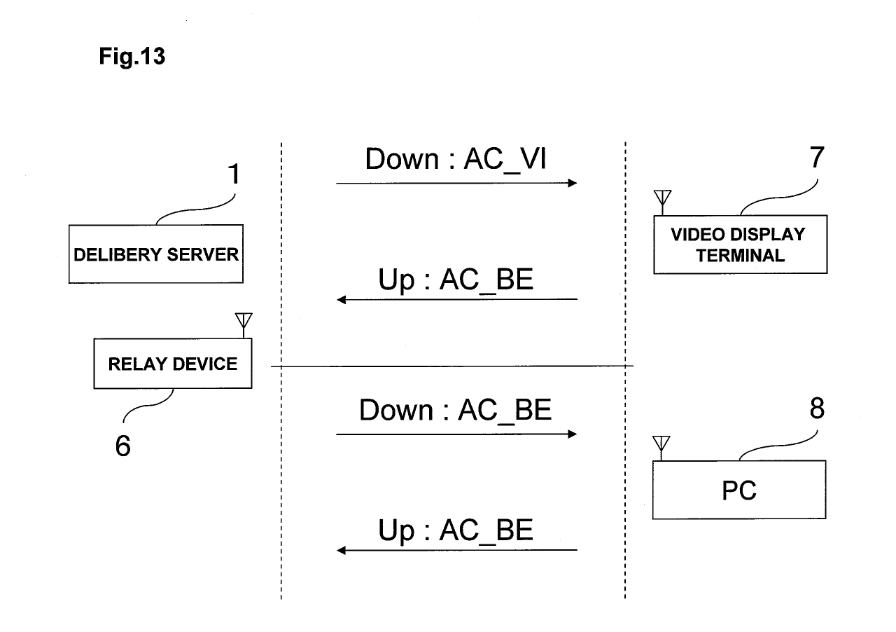

By adopting these sequences, data relayed by the relay device 6 is formed as shown in FIG. 13. Downlink stream data received by the video display terminal 7 is transmitted at the priority of AC_VI as the second highest priority in the priorities specified by the DLNA. Uplink and downlink data received by the PC 8 are transmitted at the priority of AC_BE as the third highest priority. Consequently, the data received by the priority display terminal 7 is preferentially transmitted from the relay device 6 to the terminals in the home network 5.

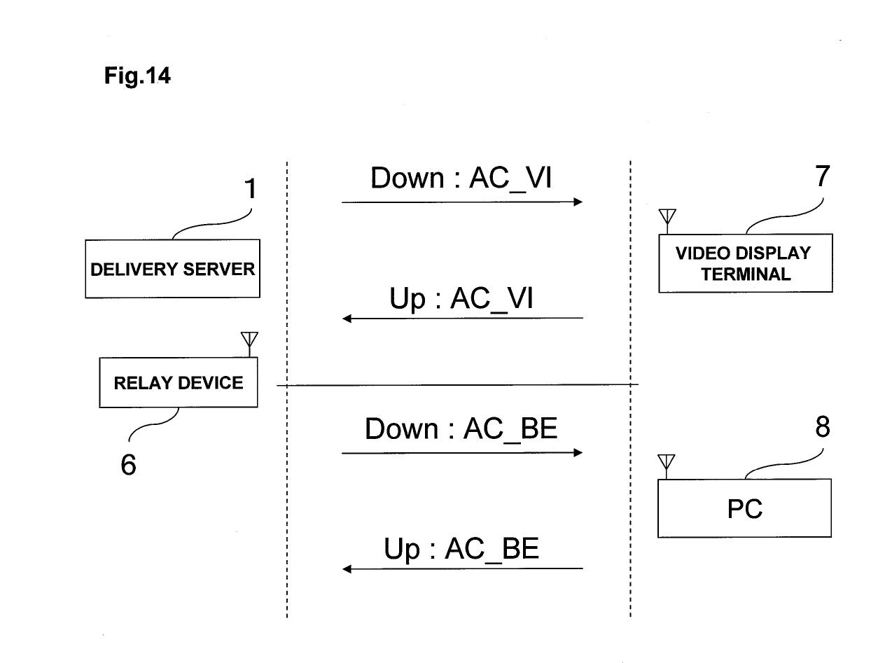

The video display terminal 7 determines, with the priority control processing unit 11, that real-time properties are necessary for the application and transmits the data, which the video display terminal 7 itself transmits, at the priority of AC_VI as shown in FIG. 14. This makes it possible to feed data transmitted and received by the video display terminal 7 more preferentially than data transmitted and received by the PC 8.

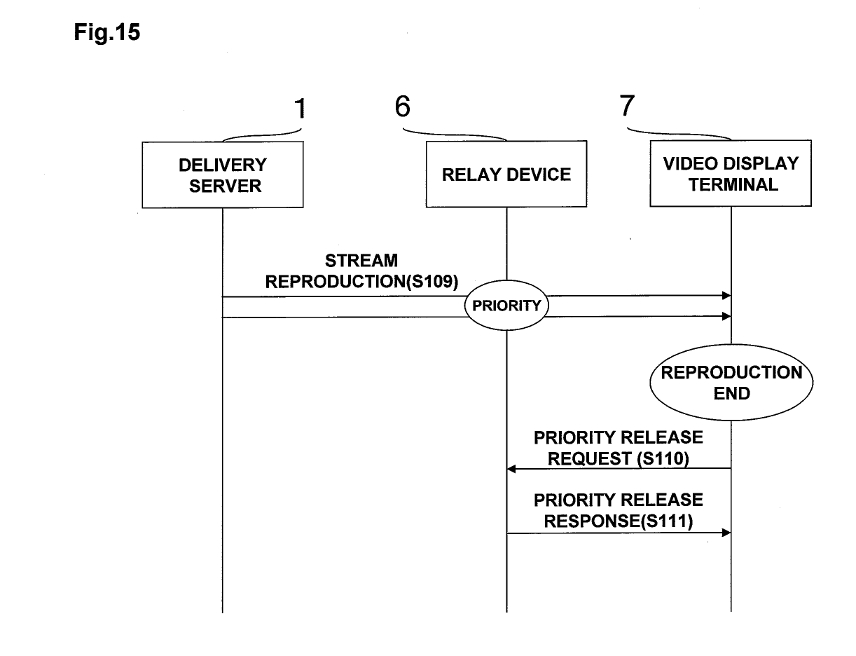

Next, a sequence in the case in which the video display terminal 7 ends the stream reproduction is described by using FIG. 15.

When the stream reproduction (S109) ends, the video display terminal 7 transmits a priority release request using the information stored in the priority control information managing unit 10 (S110).

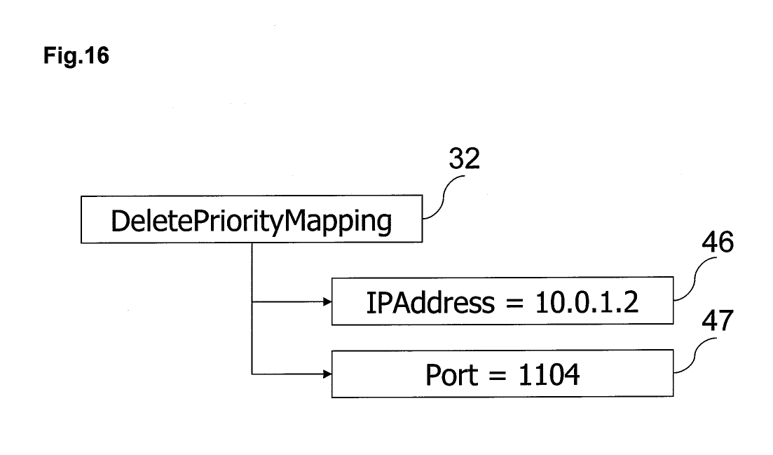

The video display terminal 7 performs this request using an action of UPnP. That is, the video display terminal 7 transmits an action shown in a service template of FIG. 16 to the Delete Priority Mapping 31 of the action of the Priority Configuration Service 29 which is the service of the priority control kept by the relay device 6. In other words, the video display terminal 7 stores 10.0.1.2 as the IP address 46 of the delivery server 1 in IPAddress, stores 1104 as the port number 47 of the content in Port, and transits the action.

The relay device 6 which has received the priority release request transmits a priority release response to the video display terminal 7 (S111) and deletes priority control information designated by the video display terminal 7 from the priority control information managing unit 22. Consequently, a function of the priority control of the relay device 6 becomes only the function of the conventional DLNA.

The video display terminal 7 which has received the priority release response (S111) deletes the priority control information, which is released for the relay device 6, from the priority control information managing unit 10.

As described above, in the priority communication control method according to the first embodiment, when the video display terminal 7 displays content requiring real-time properties from the IP public network, the video display terminal 7 searches for the relay device 6 which can apply priority control. The video display terminal 7 requests, on the basis of an IP address and other priority control information acquired from the metafile server 2, the relay device 6 to perform the priority control and causes the relay device 6 to preferentially relay the content on the basis of the information. In this way, control for keeping real-time properties is realized without separately adding new priority to stream data from the IP public network even in the home network.

### Second Embodiment

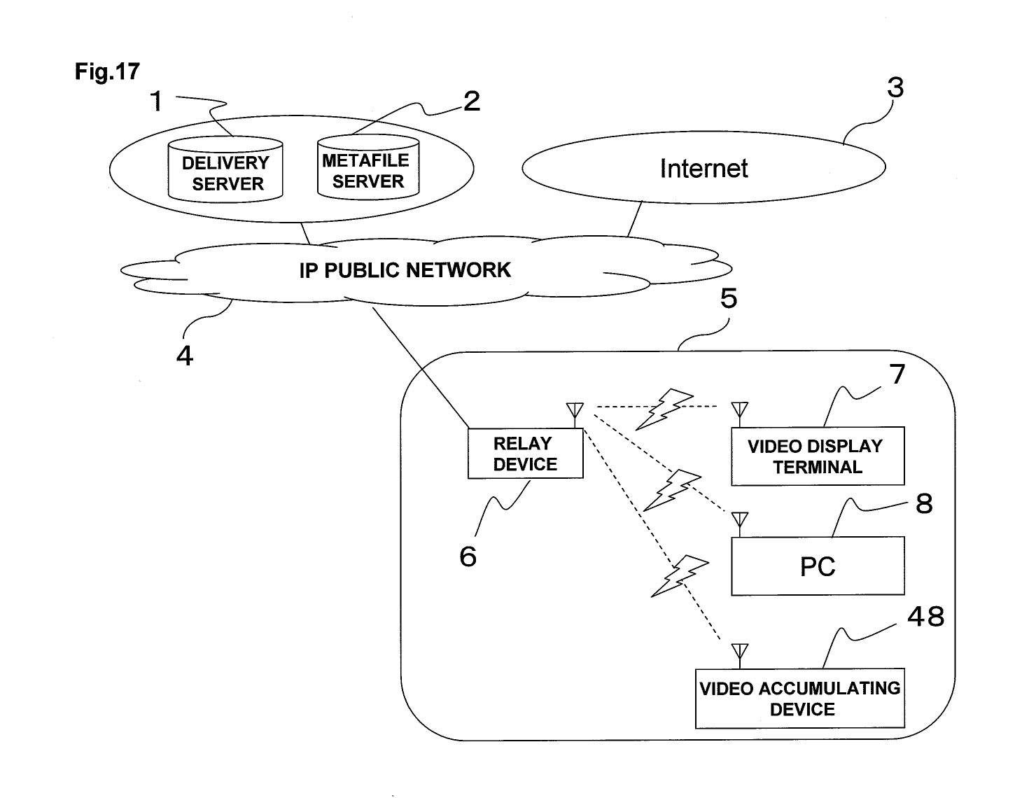

Next, the operation of the video display terminal 7 and the relay device 6 in a priority communication control method according to a second embodiment of the present invention is described. A diagram of a network system according to the second embodiment is shown in FIG. 17. The delivery server 1 for streaming content, the metafile server 2 which performs control of a metafile in which content information is described, and the Internet 3 on which other internet servers and the like are present are connected to the IP public network 4.

The home network 5 is connected to the IP public network 4. The relay device 6 such as a router is set in this home network 5. Further, the video display terminal 7, the PC 8, and a video accumulating device 48 are connected to the relay device 6 through a wireless network.

The configurations of the relay device 6 and the video display terminal 7 are the same as those in the first embodiment. The video accumulating device 48 corresponds to a storage device of the present invention.

An application assumed in the configuration of the network system shown in FIG. 17 is an application in which the PC 8 accesses the outside of a house via the relay device 6 present in the home network 5 by using the wireless network, so that a user enjoys the Internet 3 such as WEB browsing via the IP public network 4, and the video display terminal 7 stream-reproduces content in the video accumulating device 48 via the relay device 6 present in the home network 5 by using the wireless network.

That is, when the user views the content of the video accumulating device 48, the video display terminal 7 always performs communication via the relay device 6.

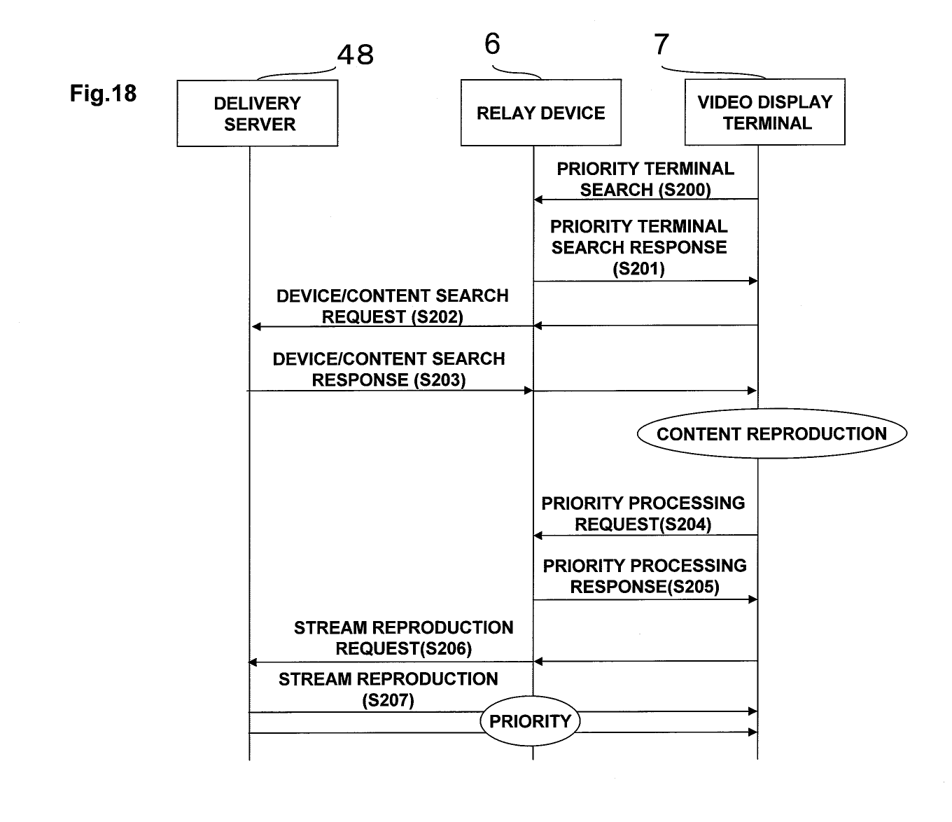

The operation of the network system according to the second embodiment of the present invention is described below with reference to a flowchart of FIG. 18. The operation of the relay device of the present invention, the operation of the terminal, and a sequence of a priority communication control method as an embodiment of the priority communication control method of the present invention are described.

First, the video display terminal 7 transmits, using UPnP, priority terminal search for searching for the relay device 6 which can apply priority processing to streaming data to be reproduced (S200).

The relay device 6 which can apply the priority processing is synonymous with searching for a device which keeps the Priority Configuration Service 29. That is, the video display terminal 7 searches for the Priority Configuration Service 29 with M-SEARCH. The relay device 6 which keeps the Priority Configuration Service 29 responds to the video display terminal 7 (priority terminal search response) (S201).

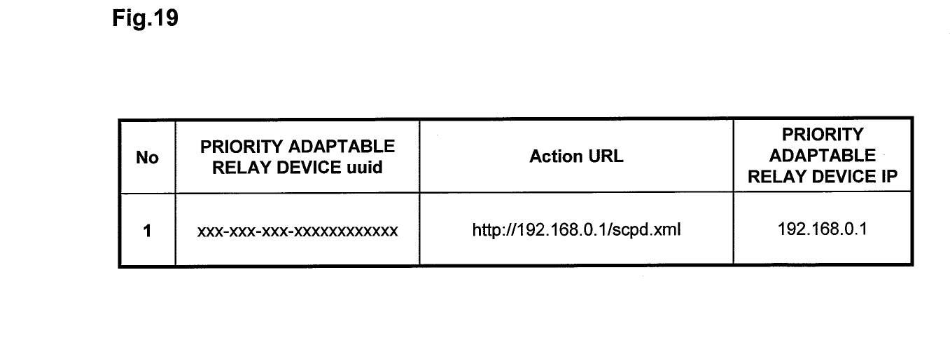

The video display terminal 7 which has received the response from the relay device 6 stores information shown in FIG. 19 in the priority control information managing unit 10 as priority control information. The information shown in FIG. 19 is, for example, uuid of the relay device 6, a URL for executing the Priority Configuration Service 29, and an IP address of the relay device 6. This is an example of the priority control information. Concerning the information to be stored, other information can be stored.

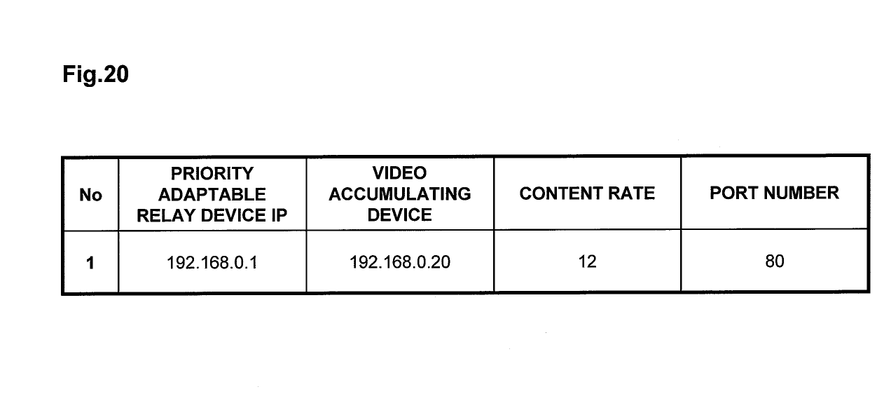

When the video display terminal 7 is instructed to display content from the video accumulating device 48 present in the home network 5, the video display terminal 7 searches for a location of the video accumulating device 48 and content stored by the video accumulating device 48 (S202). The video accumulating device 48 which has received a search request transmits a content list of the video accumulating device 48 itself to the video display terminal 7 (S203). The video display terminal 7 acquires and stores information shown in FIG. 20 in the priority control information managing unit 10 according to a response from the video accumulating device 48. The information shown in FIG. 20 is an IP address of the relay device 6, an IP address of the video accumulating device 48, a content rate, and a port number of content. However, this is only an example and other information can be stored.

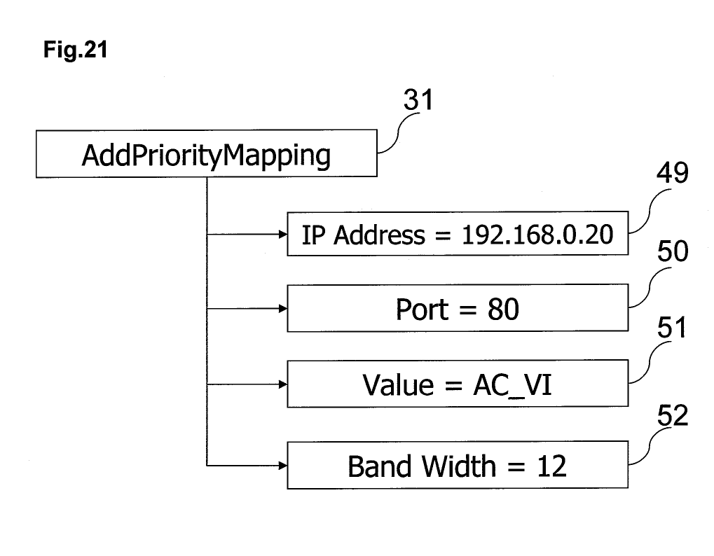

The video display terminal 7 transmits a priority processing request using the information shown in FIG. 20 stored in the priority control information managing unit 10 using an action of UPnP. That is, the video display terminal 7 transmits an action shown in FIG. 21 to the Add Priority Mapping 30 of the action of the Priority Configuration Service 29 which is the service of the priority control kept by the relay device 6. The video display terminal 7 stores (192.168.0.20) as an IP address 49 of the video accumulating device 48 in IPAddress, stores 80 as a port number 50 of content in Port, determines, with the priority control processing unit 11, that the started application requires real-time properties, stores priority AC_VI51 in Value, stores a numerical value 12 indicating a content rate in a Band Width 52, and transits the action.

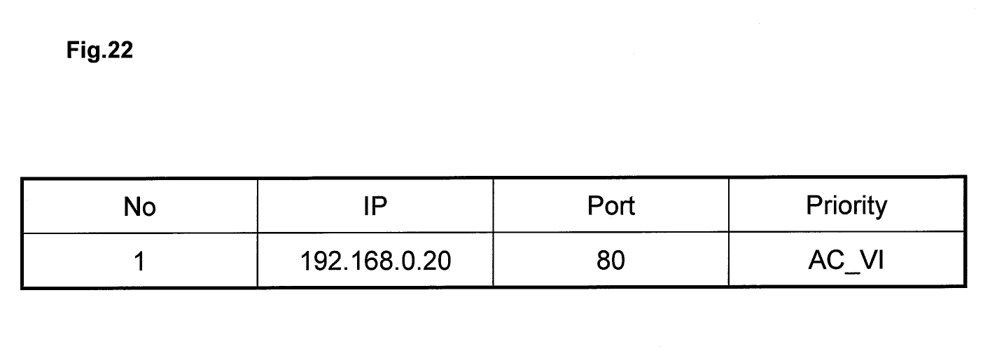

The relay device 6 which has received the priority processing request transmits a priority processing response (S205). The relay device 6 stores information shown in FIG. 22 necessary to apply priority processing to data to be received by the video display terminal 7, in the priority control information managing unit 22 as priority control information. The information to be stored is the IP address of the video accumulating device 48, the port number of the content, and the priority. However, this is only an example and other information can be stored.

The video display terminal 7 sends a request for acquisition of content to the video accumulating device 48 (S206), receives stream data from the video accumulating device 48, and starts stream reproduction (S207).

During the stream reproduction, the relay device 6 applies priority processing to a packet which coincides with the information indicated by the video display terminal 7.

As in the first embodiment, the relay device 6 which has received a priority processing request from the video display terminal 7 adds the information stored in the priority control information managing unit 22 from the video display terminal 7, to the classification criterion in the DLNA of the classifier 43 in the priority control mechanism unit 21 and preferentially transmits content data to be received by the video display terminal 7 in such manner that the content data has the second highest priority AC_VI in the priorities specified by the DLNA.

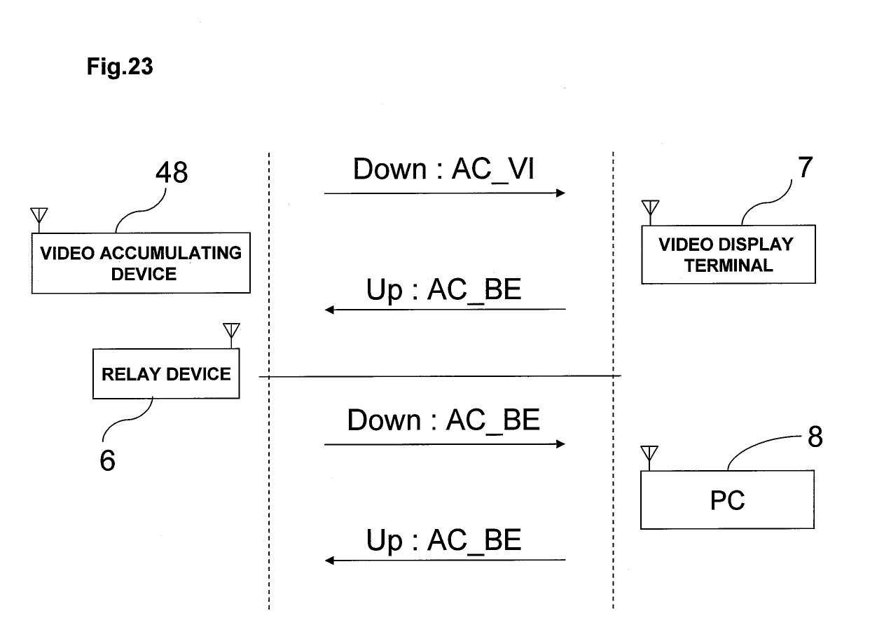

By adopting these sequences, data relayed by the relay device 6 is formed as shown in FIG. 23. Downlink stream data received by the video display terminal 7 is transmitted at the second highest priority AC_VI corresponding to video data in the priorities specified by the DLNA. Uplink and downlink data received by the PC 8 are transmitted at the third highest priority AC_BE. Consequently, the data received by the priority display terminal 7 is preferentially transmitted.

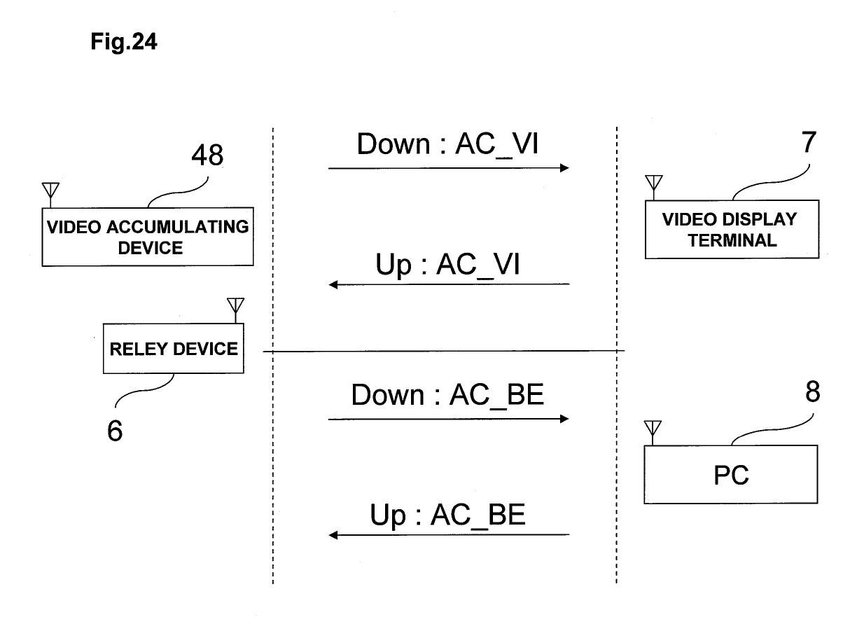

The video display terminal 7 determines, with the priority control processing unit 11, that real-time properties are necessary for the application and transmits the data, which the video display terminal 7 itself transmits, at the priority of AC_VI as shown in FIG. 24. This makes it possible to feed data transmitted and received by the video display terminal 7 more preferentially than data transmitted and received by the PC 8.

Priority processing release is the like as that in the first embodiment.

As described above, in the priority communication control method according to the second embodiment, when the video display terminal 7 displays content requiring real-time properties from the video accumulating device 48 present in the home network, the video display terminal 7 searches for the relay device 6 which can apply priority control. The video display terminal 7 requests, on the basis of an IP address of the video accumulating device 48 and other priority control information, the relay device 6 to perform the priority control and causes the relay device 6 to preferentially relay the content on the basis of the information. In this way, control for keeping real-time properties is realized without separately adding new priority to stream data from the IP public network even in the home network.

### Third Embodiment

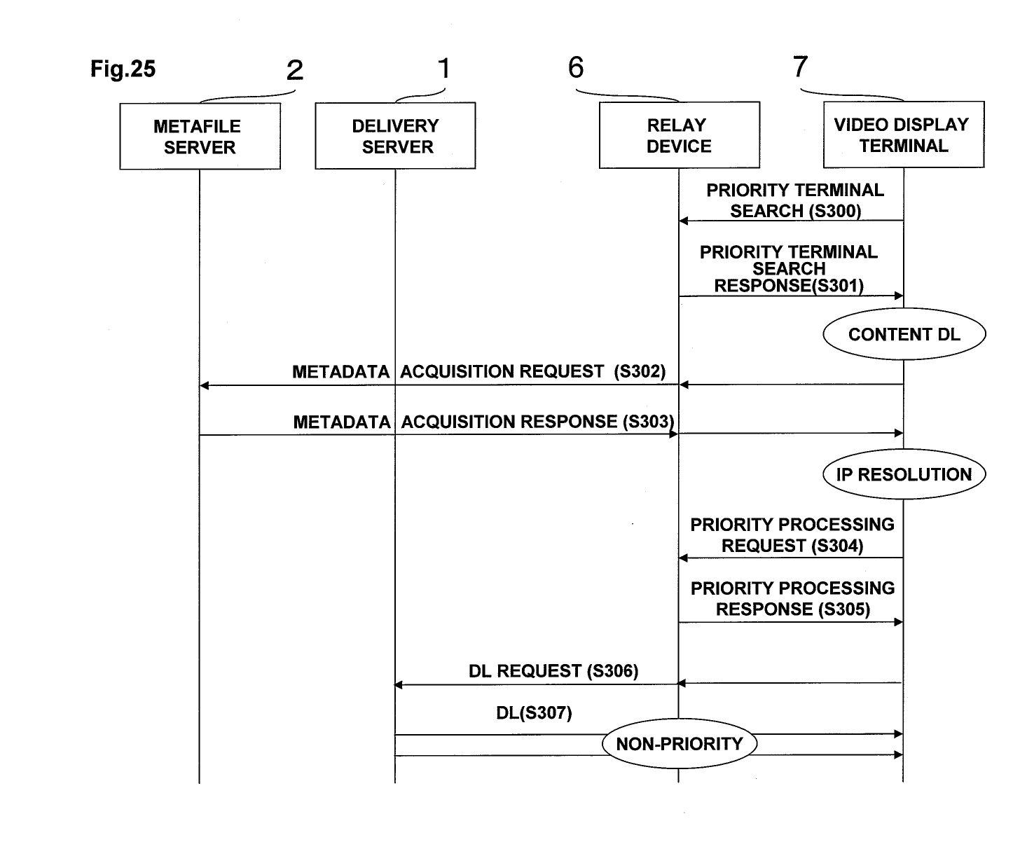

The configuration of a network system according to a third embodiment of the present invention is the same as that in the first embodiment. Only the operation of the network system is different from that in the first embodiment. The operation of the network system according to the present invention is described below. According to the explanation, the operation of a relay device according to the third embodiment of the preset invention, the operation of a terminal, and a sequence as an embodiment of the priority communication control method of the present invention are described with reference to a timing chart of FIG. 25.

As in the first embodiment, first, the video display terminal 7 transmits, using UPnP, priority terminal search for searching for the relay device 6 which can apply priority processing to data to be downloaded (DL) (S300). The relay device 6 responds to the video display terminal 7 (priority terminal search response) (S301). Consequently, the video display terminal 7 stores the information shown in FIG. 7 including the information concerning the relay device 6 in the priority control information managing unit 10 as priority control information. However, this is only an example and other information can be stored.

The information is, for example, uuid of the relay device 6, a URL for executing the Priority Configuration Service 29, and an IP address of the relay device 6. Concerning the information to be stored, other information can be stored.

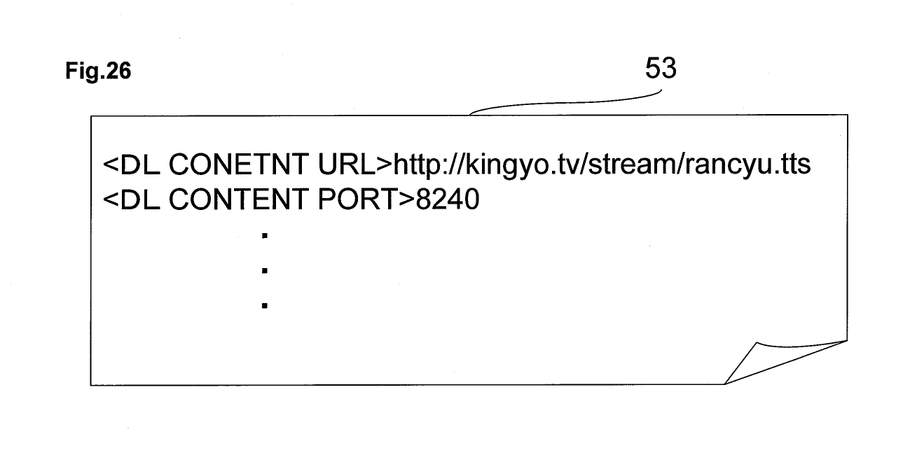

When the video display terminal 7 is instructed by a user to download content not requiring real-time properties from the IP public network 4, the video display terminal 7 requests acquisition of a metafile 53 necessary for reproducing the content from the metafile server 2 (S302). The metafile server 2 responds to the metafile acquisition request from the video display terminal 7 (S303). Information shown in FIG. 26 is described in this metafile 53. That is, the information is a URL of the DL content, a port umber of the DL content, and the like. However, a form of this metafile 53 is not specifically limited. It is enough that information necessary for the video display terminal 7 to download content from the delivery server 1 is described.

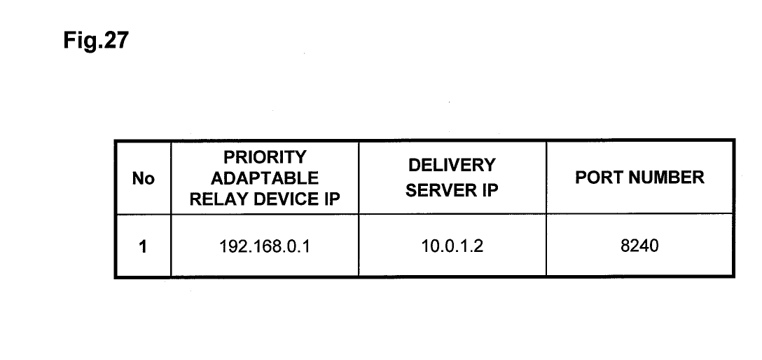

When a URL of the content is described in a metafile, the video display terminal 7 attempts to resolve an address using a DNS in order to acquire the content. When the resolution of the address ends and an IP address of the delivery server 1 is found (in this case, the IP address=10.0.1.1), the video display terminal 7 stores information shown in FIG. 27 necessary for transmission to the relay device 6 in the priority control information managing unit 10 as priority control information. In the case of an example shown in FIG. 27, the priority control information is the IP address of the relay device 6, the IP address of the delivery server 1, and a port number of the content. However, this is only an example and other information can be stored.

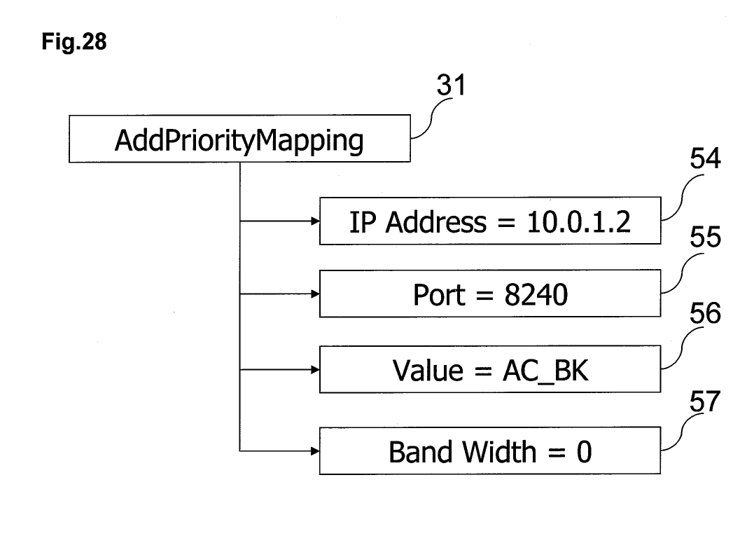

The video display terminal 7 transmits a priority processing request using the priority control information stored in the priority control information managing unit 10 (S304). The video display terminal 7 performs this request using an action of UPnP. That is, the video display terminal 7 transmits an action shown in FIG. 28 to the Add Priority Mapping 30 of the action of the Priority Configuration Service 29 which is the service of the priority control kept by the relay device 6. The video display terminal 7 stores (10.0.1.2) as an IP address 54 of the content delivery server in IPAddress, stores 8240 as a port number 55 of content in Port, determines, with the priority control processing unit 11, that the started application does not require real-time properties, stores priority AC_BK56 representing that priority is low in Value, stores a value 0 in a Band Width 57, and transits the action.

At this point, the determination by the priority control processing unit 11 that real-time properties are unnecessary is performed on the basis of a file identifier or the like of the URL described in the metafile 53 downloaded from the metafile server 2. However, the video display terminal 7 can perform the determination by acquiring other exclusive information.

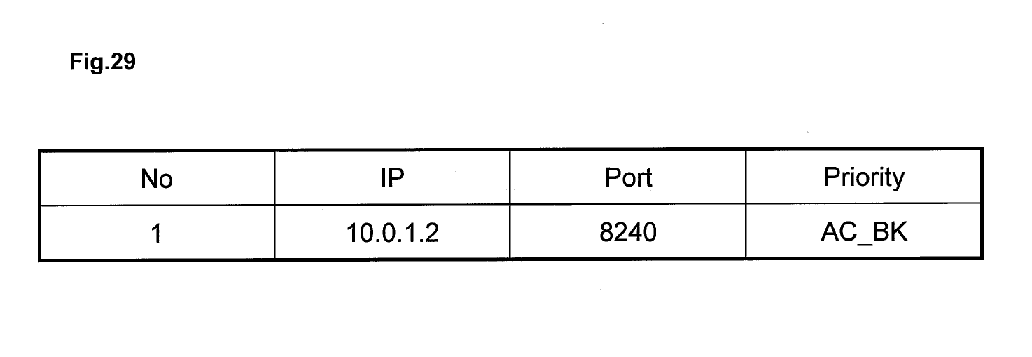

The relay device 6 which has received the priority processing request transmits a priority processing response (S305). The relay device 6 stores, in the priority control information managing unit 22, priority control information shown in FIG. 29 necessary to apply non-priority processing to data to be received by the video display terminal 7. The stored priority control information is the IP address of the delivery server 1, the port number of the content, and the priority.

The video display terminal 7 sends a request for acquisition of content to the delivery server 1 (S306) and starts download of the content from the delivery server 1 (S307).

During the download, the relay device 6 applies non-priority processing to a packet which coincides with the priority control information indicated by the video display terminal 7. That is, the relay device 6 which has received the priority processing request from the video display terminal 7 adds the priority control information based on the information stored in the priority control information managing unit 22 from the video display terminal 7, to the classification criterion of the classifier 43 in the priority control mechanism unit 21. The relay device 6 performs control to relay content data to be received by the video display terminal 7 at low unique priority in the priorities specified by the DLNA.

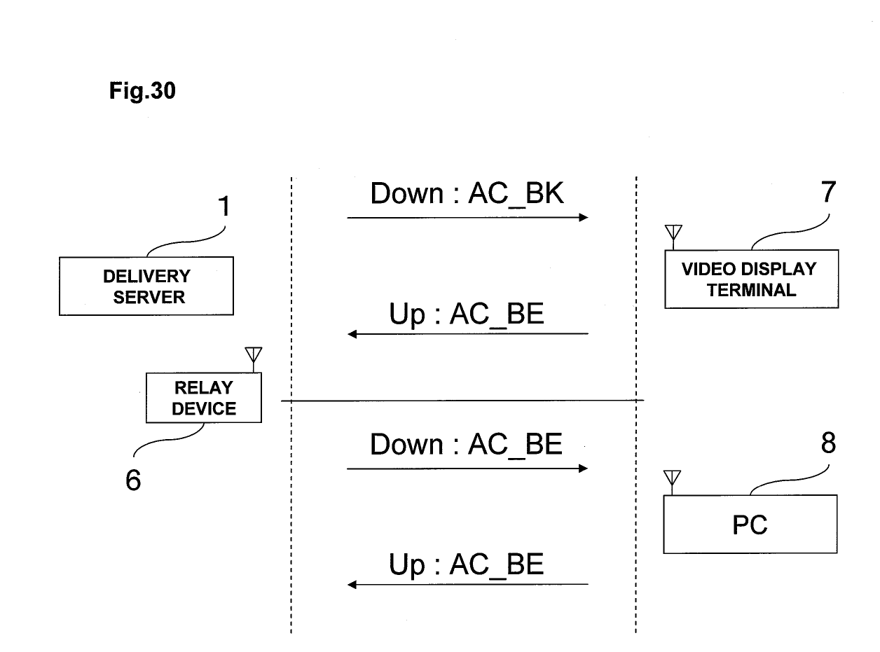

By adopting these sequences, data relayed by the relay device 6 is formed as shown in FIG. 30. That is, downlink DL data received from the delivery server 1 by the video display terminal 7 is transmitted at AC_BK as the lowest priority in the DLNA. Uplink and downlink data received by the PC 8 are transmitted at AC_BE as the third highest priority. Consequently, the data to be received by the PC 8 is preferentially transmitted.

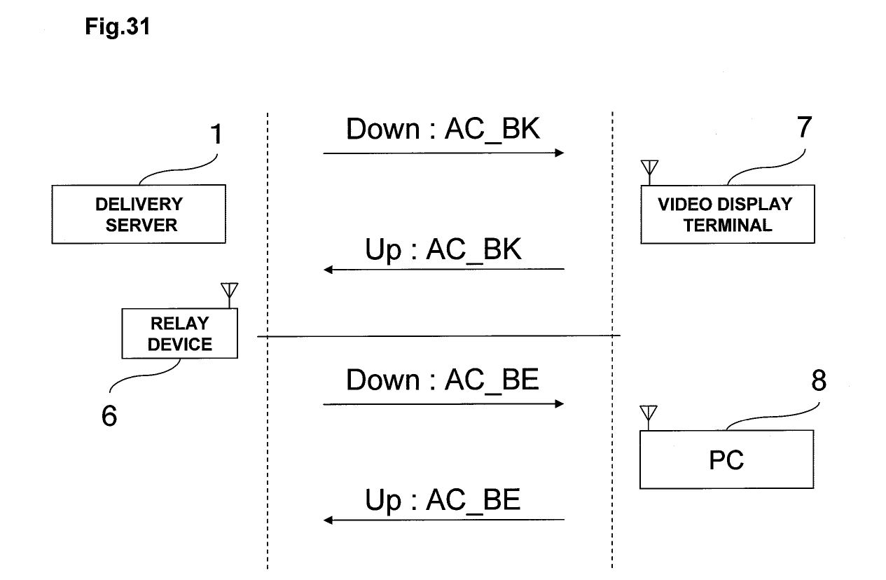

The video display terminal 7 determines, with the priority control processing unit 11, that real-time properties are unnecessary for the application and transmits the data, which the video display terminal 7 itself transmits, at the priority of AC_BK as shown in FIG. 31. This makes it possible to feed data transmitted and received by the PC 8 more preferentially than data transmitted and received by the video display terminal 7.

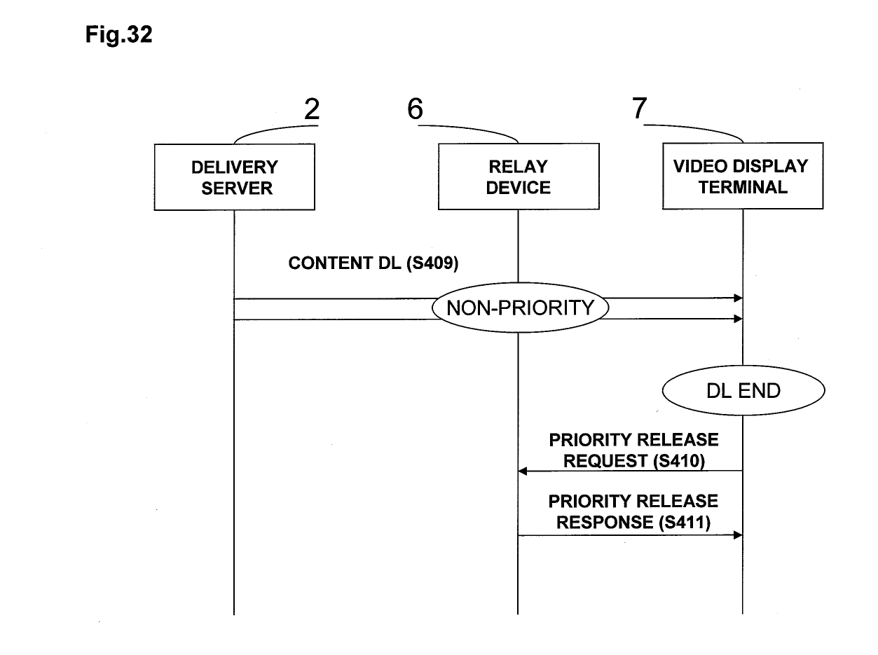

Next, a sequence in the case in which the video display terminal 7 ends the downstream of the content is the like as the sequent in the first embodiment. The sequence in the case in which the video display terminal 7 ends the download of the content is described by using FIG. 32.

When the download of the content ends, the video display terminal 7 transmits a priority release request using the information stored in the priority control information managing unit 10 (S410).

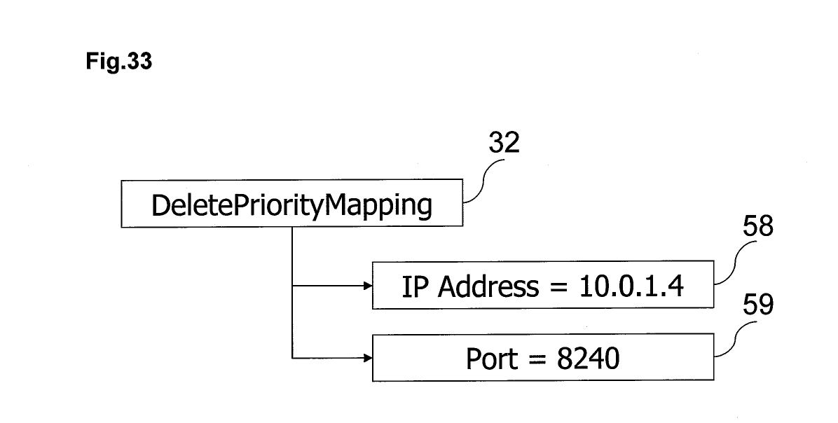

The video display terminal 7 performs this request using an action of UPnP. That is, the video display terminal 7 transmits an action shown in FIG. 33 to the Delete Priority Mapping 31 of the action of the Priority Configuration Service 29 which is the service of the priority control kept by the relay device 6. The video display terminal 7 stores (10.0.1.4) as an IP address 58 of the content delivery server in IPAddress, stores 8240 as a port number 59 of the content in Port, and transits the action. The relay device 6 which has received the priority release request transmits a priority release response (S411) and deletes the information designated by the video display terminal 7 from the priority control information managing unit 22.

The video display terminal 7 which has received the priority release response (S411) deletes the priority control information, which is released for the relay device 6, from the priority control information managing unit 10.

As described above, in the third embodiment, when the video display terminal 7 views content not requiring real-time properties from the IP public network, the video display terminal 7 searches for the relay device 6 which can apply priority control. The video display terminal 7 requests, on the basis of the information acquired from the metafile server, the relay device 6 to perform the priority control. The relay device 6 un-preferentially relays stream data from the IP public network. This makes it possible to reduce the influence on the speed of WEB browsing or the like at the PC 8 which is another terminal.

That is, according to the third embodiment, it is possible to control the priority of relay according to characteristics of real-time properties of an application from the IP public network 4. Therefore, the third embodiment is useful for preventing, for example, bandwidth from becoming insufficient in the home network 5. In the description of the third embodiment, the video display terminal 7 streaming-reproduces content from the IP public network 4. However, the similar processing can be performed when the video display terminal 7 moves or copies file data or the like from a server present on the home network. In other words, in this case, as in the case described above, it is possible to reduce the influence on the speed of WEB browsing or the like at other terminals such as the PC 8.

### Fourth Embodiment

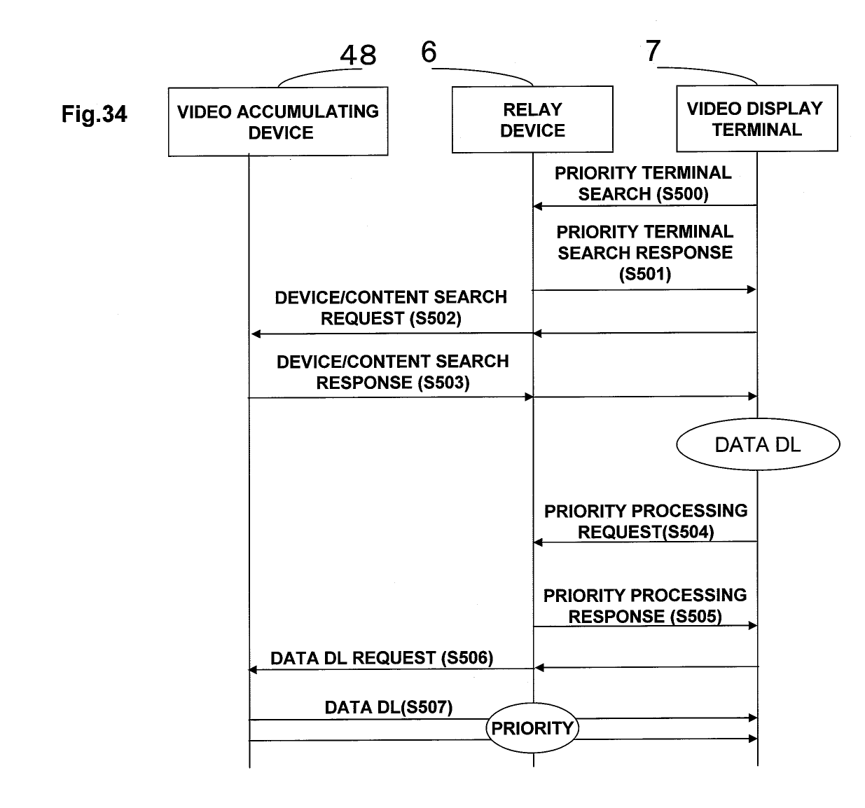

The configuration of a network system according to the fourth embodiment of the present invention is the like as that in the second embodiment. Only the operation of the network system is different from that in the second embodiment. The operation of the network system according to the present invention is described below. According to the description, the operation of a relay device according to a fourth embodiment of the preset invention, the operation of a terminal, and a sequence as an embodiment of the priority communication control method of the present invention are described with reference to a timing chart of FIG. 34.

First, the video display terminal 7 transmits, using UPnP, priority terminal search for searching for the relay device 6 which can apply priority processing to data to be downloaded (S500).

The relay device 6 which can apply the priority processing is synonymous with searching for a device which keeps the Priority Configuration Service 29. That is, the video display terminal 7 searches for the Priority Configuration Service 29 with M-SEARCH.

The relay device 6 which keeps the Priority Configuration Service 29 responds to the video display terminal 7 (priority terminal search response) (S501).

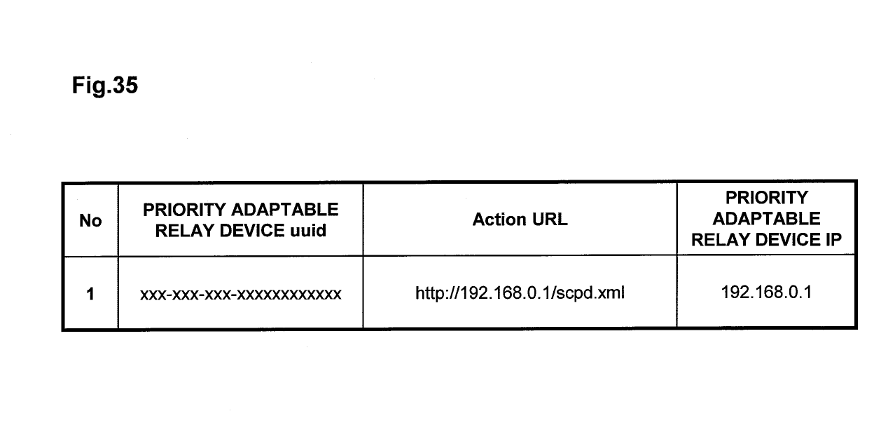

The video display terminal 7 which has received the response from the relay device 6 stores information shown in FIG. 35 in the priority control information managing unit 10 as priority control information. The information is, for example, uuid of the relay device 6, a URL for executing the Priority Configuration Service 29, and an IP address of the relay device 6. Concerning the information to be stored, other information can be stored.

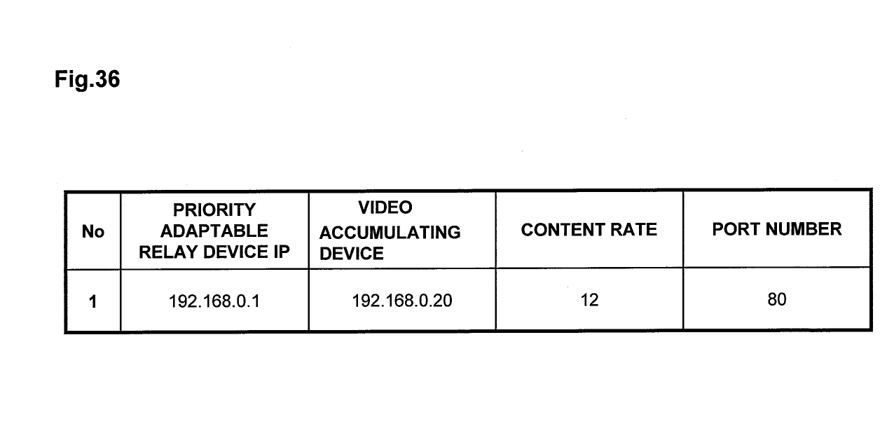

When the video display terminal 7 is instructed to execute a data transfer application not requiring real-time properties such as movement or copying of content from the video accumulating device 48 present in the home network 5, the video display terminal 7 transmits a request for search for the video accumulating device 48 and content stored by the video accumulating device 48 (S502). The video accumulating device 48 which has received the search request transmits a content list of the video accumulating device 48 to the video display terminal (S503). The video display terminal 7 stores, according to a response from the video accumulating device 48, information shown in FIG. 36 in the priority control information managing unit 10 as priority control information. In an example shown in FIG. 36, the information is an IP address of the relay device 6, an IP address of the video accumulating device 48, a content rate, and a port number of content. Concerning the information to be stored, other information can be stored.

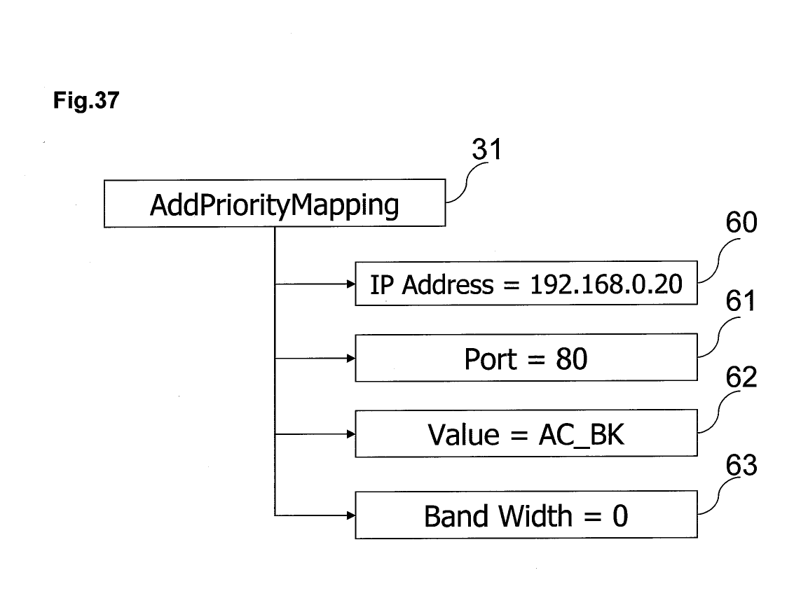

The video display terminal 7 transmits a priority processing request using the information stored in the priority control information managing unit 10 (S504). The video display terminal 7 performs this request using an action of UPnP. That is, the video display terminal 7 transmits an action shown in FIG. 37 to the Add Priority Mapping 30 for an action of the Priority Configuration Service 29 which is a service of priority control kept by the relay device 6. The video display terminal 7 stores (192.168.0.20) as an IP address 60 of the video accumulating device 48 in IPAddress, stores 80 as a port number 61 of the content in Port, determines, with the priority control processing unit 11, that the started application does not require real-time properties, stores priority AC_BK62 in Value, stores a value 0 of a content rate in BandWidth 63, and transmits the action.

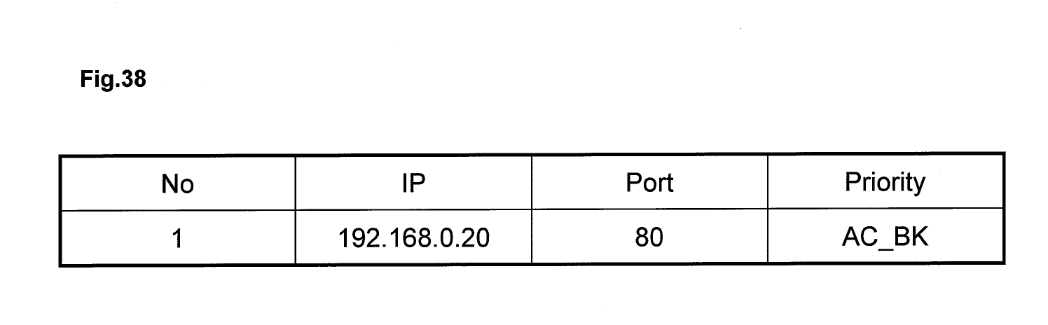

The relay device 6 which has received the priority processing request transmits a priority processing response (S505). The relay device 6 stores, in the priority control information managing unit 22, priority control information shown in FIG. 38 necessary for the video display terminal 7 to apply priority processing to received data. The stored priority control information is the IP address of the video accumulating device 48, the port number of the content, and the priority. The video display terminal 7 sends a request for acquisition of content to the video accumulating device 48 (S506) and starts download of the content from the video accumulating device 48 (S507).

During the download, the relay device 6 applies non-priority processing to a packet which coincides with the information indicated by the video display terminal 7.

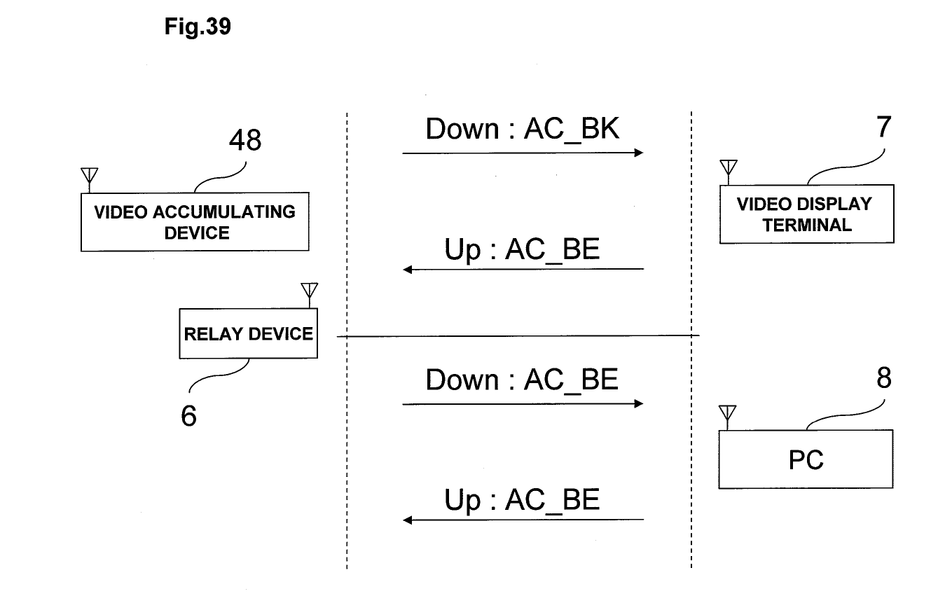

By adopting these sequences, data relayed by the relay device 6 is formed as shown in FIG. 39. Downlink DL data to be by the video display terminal 7 from the video accumulating device 48 is transmitted at the priority AC_BK. Uplink and downlink data received by the PC 8 are transmitted at the priority of AC_BE. Consequently, the data received by the PC 8 is preferentially transmitted.

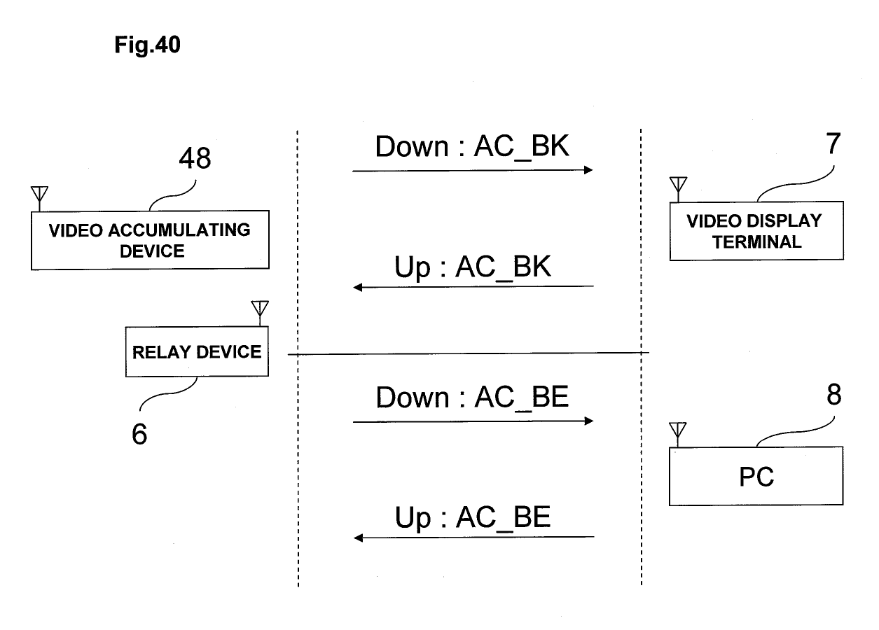

The video display terminal 7 determines, with the priority control processing unit 11, that real-time properties are unnecessary for the application and transmits the data, which the video display terminal 7 itself transmits, at the priority of AC_BK as shown in FIG. 40. This makes it possible to feed data transmitted and received by the PC 8 more preferentially than data transmitted and received by the video display terminal 7.

As described above, with the priority communication control method according to the fourth embodiment, when the video display terminal 7 views content not requiring real-time properties from the home network 5, the video display terminal 7 searches for the relay device 6 which can apply priority control. The video display terminal 7 requests, on the basis of the information acquired from the video accumulating device 48, the relay device 6 to perform the priority control. The relay device 6 un-preferentially relays data from the video accumulating device 48. This makes it possible to reduce the influence on the speed of WEB browsing or the like at the PC 8.

That is, according to the present invention, it is possible to control the priority of relay according to characteristics of real-time properties of an application from the video accumulating device 48. Therefore, the present invention is useful for preventing, for example, bandwidth from becoming insufficient in the home network 5.

A program according to the present invention can be a program for causing a computer to execute the operation in the step of performing data transfer between the storage device and the terminal at a predetermined priority set on the basis of information received from the terminal for specifying the storage, of the priority communication control method of the present invention illustrated in the embodiments described above, wherein the program operates in cooperation with the computer.

The program according to the present invention can be a program for causing a computer to execute the operation in the step of acquiring information for specifying the content according to an input of a user, the step of acquiring at least an address of the storage device storing therein the content specified by the information, the step of transmitting the address acquired by the acquiring unit to the relay device, and the step of performing data transfer with the storage device at a predetermined priority set by the relay device on the basis of information for specifying the storage received from the terminal, of the priority communication control method of the present invention illustrated in the embodiments, wherein the program operates in cooperation with the computer.

The present invention can be a recording medium having recorded therein a program for causing a computer to execute all or a part of the steps of the priority communication control method of the present invention described above, wherein the program is readable and the read program operates in cooperation with the computer.

The “operation of the step” of the present invention means the operation of the entire step or a part of the step.

A manner of use of the program of the present invention can be a manner in which the program is recorded in a recording medium such as a ROM readable by a computer and operates in cooperation with the computer.

A manner of use of the program of the present invention can be a manner in which the program is transmitted through a transmission medium such as the Internet or a transmission medium such as light or radio wave and read by a computer and operates in cooperation with the computer.

The computer of the present invention can include not only pure hardware such as a CPU but also firmware, an OS, and peripheral apparatuses.

As described above, the configuration of the present invention can be realized in terms of software or can be realized in terms of hardware.

### INDUSTRIAL APPLICABILITY

The terminal, the relay device, the priority communication control method, the program, and the recording medium according to the present invention, have an advantage that it is possible to smoothly deliver data while guaranteeing real-time properties on a home network which takes into account data capturing from a public network. The present invention is useful for a terminal, a relay device, a priority communication control method, a program, a recording medium, and the like.

1. A relay device which controls data transfer between one or plural storage devices having content stored therein and one or plural terminals, the relay device comprising:
a transfer unit which performs, when apparatus information for specifying an apparatus concerning the data transfer of the content, is received from the terminal, the data transfer of the content at a predetermined priority set on the basis of the apparatus information.

2. The relay device according to claim 1, wherein
the apparatus information includes one or both of:
(1) information for specifying the storage device having the content stored therein; and
(2) information for specifying a terminal of a data transfer destination of the content.

3. The relay device according to claim 1, comprising:
a communication interface for transmitting and receiving data to and from the storage device and the terminal;
a transmission and reception processing unit which controls data received from the communication interface and data to be transmitted by the transmission and reception processing unit itself;
a relay control unit which applies relay control to the data from the communication interface; and
a protocol processing unit which processes a protocol from the terminal, wherein
the transfer unit includes
a priority control processing unit which processes a request for priority control and a request for release of the priority control from the terminal,
a priority control information managing unit which accumulates and manages information concerning the terminal and information necessary for the priority control, and
a priority control mechanism unit which performs priority control processing.

4. The relay device according to claim 3, wherein,
when a request for the priority control is received from the terminal,
the priority control processing unit adds said predetermined priority to determination indexes for the priority processing, which are used in communication among the terminals, for determining priority from a field of data in which priorities are described, and performs the priority processing.

5. The relay device according to claim 3, wherein,
when a release request for the priority control is received from the terminal,
the priority control processing unit deletes the predetermined priority from determination indexes for the priority processing, which are used in communication among the terminals, for determining priority from a field of data in which priorities are described.

6. The relay device according to claim 1, wherein
a function of the transfer unit is defined right below a root device.

7. A terminal connected to, via a relay device, one or plural storage devices having content stored therein,
the terminal comprising:
a user interface which acquires information for specifying content according to an input of a user;
a transmitting unit which transmits apparatus information for specifying an apparatus concerning data transfer of the content, to the relay device; and
a communication unit which performs data transfer with the storage device at a predetermined priority set by the relay device on the basis of the apparatus information received from the terminal.

8. The terminal according to claim 7, wherein
the apparatus information includes one or both of:
(1) information for specifying the storage device having the content stored therein; and
(2) information for specifying the terminal itself, and
the terminal includes an acquiring unit which acquires information for specifying the storage device storing the content specified by the information.

9. The terminal according to claim 7, wherein
the terminal belongs to a local network together with the relay device,
the storage device belongs to a wide area network, and
the information for specifying the content includes information for distinguishing the local network and the wide area network.

10. The terminal according to claim 8, wherein
the acquiring unit acquires the information for specifying the storage device, from a metafile server belonging to the wide area network and having recorded therein the information for specifying the storage device having stored therein the content specified by the information.

11. The terminal according to claim 8, further comprising:
a communication interface including the communication unit and for transmitting and receiving data to and from the storage device;
a transmission and reception processing unit which controls data received from the communication interface or data to be transmitted by the transmission and reception processing unit itself;
a protocol processing unit which processes a protocol with the relay device;
a terminal data processing unit which processes data from the storage device; and
a video display unit which outputs processed video to a screen, wherein
the acquiring unit includes
a priority control processing unit which searches for the relay device according to at least an input to the user interface and processes a request for priority control and a request for release of the priority control to the relay device,
a priority control information managing unit which accumulates and manages information necessary for performing the request for the priority control and the request for release of the priority control to the replay device, and
a priority control mechanism unit which performs priority control processing.

12. The terminal according to claim 11, wherein,
when stream reproduction which requires real-time properties, from the storage device is executed, the priority control processing unit requests the relay device to set priority equal to or higher than priorities of other data and relay the data.

13. The terminal according to claim 11, wherein,
when stream reproduction which does not require real-time properties, from the storage device is executed, the priority control processing unit requests the relay device to set priority equal to or lower than priorities of other data and relay the data.

14. A priority communication control method for controlling data transfer between one or plural storage devices having content stored therein and one or plural terminals, the priority communication control method comprising:
performing, when apparatus information for specifying content and an apparatus concerning data transfer of the content is received from the terminal, the data transfer between the storage device and the terminal at a predetermined priority set on the basis of the apparatus information.

15. A priority communication control method for performing control for causing a terminal connected to one or plural storage devices having content stored therein to receive data from the storage device via a relay device, the priority communication control method comprising:
a step of acquiring information for specifying the content according to an input of a user;
a step of transmitting apparatus information for specifying an apparatus concerning data transfer of the content to the relay device; and
a step of performing data transfer with the storage device at a predetermined priority set by the relay device on the basis of the apparatus information for specifying an apparatus concerning data transfer of the content, received from the terminal.

16. A program, embodied on a non-transitory computer-readable medium, for causing a computer to execute a priority communication control method for controlling data transfer between one or plural storage devices having content stored therein and one or plural terminals, the priority communication control method comprising:
performing, when apparatus information for specifying content and an apparatus concerning data transfer of the content is received from the terminal, the data transfer between the storage device and the terminal at a predetermined priority set on the basis of the apparatus information.

17. A program, embodied on a non-transitory computer-readable medium, for causing a computer to execute a priority communication control method for performing control for causing a terminal connected to one or plural storage devices having content stored therein to receive data from the storage device via a relay device, the priority communication control method comprising:
acquiring information for specifying the content according to an input of a user;
transmitting apparatus information for specifying an apparatus concerning data transfer of the content, to the relay device; and
performing data transfer with the storage device at a predetermined priority set by the relay device on the basis of the apparatus information for specifying an apparatus concerning data transfer of the content, received from the terminal.

18. (canceled)
